(19) United States
(12) Patent Application Publication
(10) Pub. No.: US 2026/0004406 A1
(43) Pub. Date: Jan. 1, 2026

(54) IMAGE GENERATION METHOD, DEVICE, AND MEDIUM

(71) Applicant: Beijing Zitiao Network Technology Co., Ltd., Haidian District (CN)

(72) Inventor: Li CHEN, Beijing (CN)

(21) Appl. No.: 19/252,379

(22) Filed: Jun. 27, 2025

(30) Foreign Application Priority Data
Jun. 28, 2024 (CN) 202410867205.3

(51) Int. Cl. G06T 5/70; G06V 10/44; G06V 10/80

(52) U.S. Cl. CPC G06T 5/70; G06V 10/44; G06V 10/806

(57) ABSTRACT

An image generation method, device, and medium are disclosed. The method includes: obtaining to-be-processed noise, a text feature of a target text, an identity document (ID) feature of a target object in a first image, a time step sequence including first time steps, second time steps, third time steps and fourth time steps; processing these first time steps, the to-be-processed noise, and the text feature using a first denoising network to obtain a first result; processing these second time steps, the first result, the text feature, and the ID feature using a second denoising network to obtain a second result; processing these third time steps, the second result, and the text feature using a third denoising network to obtain a third result; and processing these fourth time steps, the third result, the text feature, and the ID feature using a fourth denoising network to obtain a second image.

### CROSS-REFERENCE TO RELATED APPLICATION

The present application claims the priority to and benefits of Chinese Patent Application No. 202410867205.3, which was filed on Jun. 28, 2024. The aforementioned patent application is hereby incorporated by reference in its entirety.

### TECHNICAL FIELD

The present disclosure relates to the field of computer technologies, and in particular, to an image generation method and apparatus, a device, a medium, and a product.

### BACKGROUND

For some scenarios, there may be image generation requirements as follows: generating a new image based on a text and an image provided by a user, with the expectation that the new image achieves the following effects: an identity document (ID) feature of a target object in the new image, such as the face or head, remains consistent with an ID feature of the target object in the image provided by the user, and information described by the new image remains consistent with semantic information described by the text.

However, how to meet the aforementioned image generation requirements has become a pressing technical problem to be resolved.

### SUMMARY

The present disclosure provides an image generation method and apparatus, a device, a medium, and a product that can better meet the aforementioned image generation requirements.

To achieve the above object, the present disclosure provides the following technical solutions.

The present disclosure provides an image generation method. The method includes:
obtaining noise to be processed, a time step sequence, a text feature of a target text, and an identity document (ID) feature of a target object in a first image, where the time step sequence includes at least one first time step, at least one second time step, at least one third time step, and at least one fourth time step;
processing the at least one first time step, the noise to be processed, and the text feature using a first denoising network to obtain a first result, where input data to a cross attention module within the first denoising network includes the text feature;
processing the at least one second time step, the first result, the text feature, and the ID feature using a second denoising network to obtain a second result, where input data to a cross attention module within the second denoising network includes the text feature and the ID feature;
processing the at least one third time step, the second result, and the text feature using a third denoising network to obtain a third result, where input data to a cross attention module within the third denoising network includes the text feature; and
processing the at least one fourth time step, the third result, the text feature, and the ID feature using a fourth denoising network to obtain a second image, where input data to a self attention module within the fourth denoising network includes the ID feature, and input data to a cross attention module within the fourth denoising network includes the text feature.

In a possible implementation, for any time step in the time step sequence, a feature map corresponding to the time step is used to represent information carried by a noise image corresponding to the time step, with the noise image corresponding to the time step being determined based on the time step and the noise to be processed;
for any first time step, the cross attention module within the first denoising network is configured to perform cross attention processing based on the text feature and a feature map corresponding to the first time step;
for any second time step, the cross attention module within the second denoising network is configured to perform cross attention processing based on the text feature, the ID feature, and a feature map corresponding to the second time step;
for any third time step, the cross attention module within the third denoising network is configured to perform cross attention processing based on the text feature and a feature map corresponding to the third time step; and
for any fourth time step, the self attention module within the fourth denoising network is configured to perform attention processing based on the ID feature and a feature map corresponding to the fourth time step, and the cross attention module within the fourth denoising network is configured to perform cross attention processing based on the text feature and the feature map corresponding to the fourth time step.

In a possible implementation, for any first time step, a noise image corresponding to the first time step is determined based on the first time step and the noise to be processed;
for any second time step, a noise image corresponding to the second time step is determined based on the second time step and the first result;
for any third time step, a noise image corresponding to the third time step is determined based on the third time step and the second result; and
for any fourth time step, a noise image corresponding to the fourth time step is determined based on the fourth time step and the third result.

In a possible implementation, the target text includes a target entity, with the target entity belonging to a preset entity type;
the first result includes an attention map of the target entity, with the attention map being used to describe an image region where the target entity is located; and
for any second time step, the cross attention module within the second denoising network is configured to: process the image region in a feature map corresponding to the second time step based on the ID feature, and process regions other than the image region in the feature map corresponding to the second time step based on the text feature.

In a possible implementation, the target text includes a target entity, with the target entity belonging to a preset entity type;
the third result includes an attention map of the target entity, with the attention map being used to describe an image region where the target entity is located; and
for any fourth time step, the self attention module within the fourth denoising network is configured to: perform attention processing based on the ID feature and the image region in a feature map corresponding to the fourth time step.

In a possible implementation, a process of determining the target entity includes:
performing entity recognition processing on the target text to obtain a plurality of candidate entities, each of the candidate entities belonging to the preset entity type; and
searching for a target entity that matches the first image from among the plurality of candidate entities.

In a possible implementation, the first denoising network is a denoising network in a first diffusion model, with the first diffusion model further including a text encoder, where the input data to the cross attention module within the first denoising network includes output data from the text encoder;
the second denoising network is a denoising network in a second diffusion model, with the second diffusion model further including the text encoder and an ID feature extraction module, where the input data to the cross attention module within the second denoising network includes the output data from the text encoder and output data from the ID feature extraction module;
the third denoising network is a denoising network in a third diffusion model, with the third diffusion model further including the text encoder, where the input data to the cross attention module within the third denoising network includes the output data from the text encoder; and
the fourth denoising network is a denoising network in a fourth diffusion model, with the fourth diffusion model further including the text encoder and the ID feature extraction module, where the input data to the self attention module within the fourth denoising network includes the output data from the ID feature extraction module, and the input data to the cross attention module within the fourth denoising network includes the output data from the text encoder.

In a possible implementation, the text feature is obtained by encoding the target text through the text encoder; and
the ID feature of the target object in the first image is obtained by processing the first image through the ID feature extraction module.

In a possible implementation, the ID feature extraction module includes a multi-layer feature extraction module and a feature fusion module, with output data from the multi-layer feature extraction module including image features of a plurality of sizes, and the feature fusion module being configured to perform fusion processing on image features of some or all of the plurality of sizes.

In a possible implementation, the first denoising network includes a first noise predictor, and the cross attention module within the first denoising network includes a cross attention module within the first noise predictor;
the second denoising network includes a second noise predictor, and the cross attention module within the second denoising network includes a cross attention module within the second noise predictor;
the third denoising network includes a third noise predictor, and the cross attention module within the third denoising network includes a cross attention module within the third noise predictor; and
the fourth denoising network includes a fourth noise predictor, and the self attention module within the fourth denoising network includes a self attention module within the fourth noise predictor, and the cross attention module within the fourth denoising network includes a cross attention module within the fourth noise predictor.

The present disclosure provides an image generation apparatus, including:
a data obtaining unit configured to obtain noise to be processed, a time step sequence, a text feature of a target text, and an identity document (ID) feature of a target object in a first image, where the time step sequence includes at least one first time step, at least one second time step, at least one third time step, and at least one fourth time step;
a first processing unit configured to process the at least one first time step, the noise to be processed, and the text feature using a first denoising network to obtain a first result, where input data to a cross attention module within the first denoising network includes the text feature;
a second processing unit configured to process the at least one second time step, the first result, the text feature, and the ID feature using a second denoising network to obtain a second result, where input data to a cross attention module within the second denoising network includes the text feature and the ID feature;
a third processing unit configured to process the at least one third time step, the second result, and the text feature using a third denoising network to obtain a third result, where input data to a cross attention module within the third denoising network includes the text feature; and
a fourth processing unit configured to process the at least one fourth time step, the third result, the text feature, and the ID feature using a fourth denoising network to obtain a second image, where input data to a self attention module within the fourth denoising network includes the ID feature, and input data to a cross attention module within the fourth denoising network includes the text feature.

The present disclosure provides an electronic device. The device includes: a processor and a memory, where
the memory is configured to store instructions or a computer program; and
the processor is configured to execute the instructions or computer program in the memory to cause the electronic device to perform the image generation method according to the present disclosure.

The present disclosure provides a computer-readable medium having instructions or a computer program stored therein which, when run on a device, causes the device to perform the image generation method according to the present disclosure.

The present disclosure provides a computer program product including a computer program carried on a non-transitory computer-readable medium, where the computer program includes program code for performing the image generation method according to the present disclosure.

### BRIEF DESCRIPTION OF DRAWINGS

In order to more clearly describe the technical solutions in the embodiments of the present disclosure or in the related art, the drawings for describing the embodiments or the related art will be briefly described below. Apparently, the drawings in the description below show merely some embodiments recited in the present disclosure, and persons of ordinary skill in the art may still derive other drawings from these drawings without creative efforts.

FIG. 1 is a flowchart of an image generation method according to an embodiment of the present disclosure;

FIG. 2 is a schematic diagram of a denoising process according to an embodiment of the present disclosure;

FIG. 3 is a schematic diagram of another denoising process according to an embodiment of the present disclosure;

FIG. 4 is a schematic diagram of yet another denoising process according to an embodiment of the present disclosure;

FIG. 5 is a schematic diagram of a model training method according to an embodiment of the present disclosure;

FIG. 6 is a schematic diagram of a structure of an image generation apparatus according to an embodiment of the present disclosure; and

FIG. 7 is a schematic diagram of a structure of an electronic device according to an embodiment of the present disclosure.

### DETAILED DESCRIPTION

Through research, it has been found that a diffusion model can be used for various image generation tasks. The diffusion model includes at least a denoising network. The denoising network is configured to generate a new image based on noise to be processed and features of at least one type of information provided by a user. Additionally, the denoising network may include at least a noise predictor (e.g., a Unet) and a noise removal module. At each time step, the working principle of the denoising network is as follows: first, the noise predictor performs noise prediction processing on the current noise image to obtain predicted noise; then, the noise removal module removes this predicted noise from the current noise image to obtain an image with the noise removed. As can be seen, after implementing noise removal processing at all time steps by means of this denoising network, a new image can be obtained. Here, the noise to be processed refers to data that requires noise removal processing by means of the denoising network.

To facilitate understanding of the content in the preceding paragraph, the following will provide explanations in conjunction with an example.

As an example, assume that the time step sequence for the denoising process of the diffusion model is {Step_{T}, Step_{T-1}, Step_{T-3}, Step_{T-2}, . . . , Step₁}, and the at least one type of information provided by the user includes a text, such as the text “a photo of a man and a dog”. Here, T is a positive integer.

Based on the assumptions in the preceding paragraph, the image generation process implemented using the denoising network in the diffusion model can be described as follows. First, the Unet in the denoising network performs noise prediction processing based on the noise to be processed, Step_{T}, and a text feature of the text to obtain predicted noise corresponding to the Step_{T}, and the noise removal module within the denoising network removes the predicted noise corresponding to the Step_{T} from the noise to be processed to obtain a noise image corresponding to the Step_{T-1}. Next, the Unet performs noise prediction processing based on the noise image corresponding to the Step_{T-1}, the Step_{T-1}, and the text feature to obtain predicted noise corresponding to the Step_{T-1}, and the noise removal module removes the predicted noise corresponding to the Step_{T-1} from the noise image corresponding to the Step_{T-1} to obtain a noise image corresponding to the Step_{T-2}. Subsequently, the Unet performs noise prediction processing based on the noise image corresponding to the Step_{T-2}, the Step_{T-2}, and the text feature to obtain predicted noise corresponding to the Step_{T-2}, and the noise removal module removes the predicted noise corresponding to the Step_{T-2} from the noise image corresponding to the Step_{T-2} to obtain a noise image corresponding to the Step_{T-3} . . . . (And so on). Finally, the Unet performs noise prediction processing based on a noise image corresponding to the Step₁, the Step₁, and the text feature to obtain predicted noise corresponding to the Step₁, and the noise removal module removes the predicted noise corresponding to the Steps from the noise image corresponding to the Step₁ to obtain a new image.

When meeting the aforementioned image generation requirements by means of the diffusion model, the image generation process based on this diffusion model may at least include: at each time step, introducing the features of all the information provided by the user, such as an ID feature of a target object (e.g., face) in the image provided by the user and a feature of the text provided by the user, into a cross attention (CA) module of the Unet within the diffusion model, so that the CA module can perform processing based on these features.

The implementation scheme presented in the preceding paragraph has the defects as follows. Since the ID feature needs to be introduced at each time step so that the ID feature has a considerable impact on the image generation process, the finally generated new image more closely resembles the image provided by the user. This can easily lead to a substantial discrepancy between the information described by the new image and the semantic information described by the text. Consequently, this implementation scheme has a poor editing capability, leading to suboptimal image generation effect.

In order to overcome the defects mentioned in the preceding paragraph, the ID feature can be omitted in some time steps, allowing these time steps to proceed with generation processing without the constraint of the ID feature; and then the ID feature can be introduced in the remaining time steps, enabling these remaining time steps to carry out generation processing under the constraint of the ID feature. In this case, since the ID feature is not introduced during the initial generation stage, the target object generated in the initial generation stage may differ significantly from the target object in the image provided by the user, making it difficult or even impossible to perform ID feature retention processing in the later generation stage. This results in significant differences between the ID feature of the target object in the finally generated new image and the ID feature of the target object in the image provided by the user. Consequently, this implementation scheme exhibits a poor ID feature retention capability, leading to suboptimal image generation effect.

The reason for the inability to achieve ID feature retention in the later generation stage in the preceding paragraph is: the ID feature is introduced too late, which leads to a decrease in the editing capability. Moreover, it has been further found t that adopting different methods of introducing the ID feature results in different effects. Employing different methods to introduce the ID feature at different times can produce varying image generation effect. This makes the timing and method for introducing the ID feature an important influencing factor.

In order to further improve the image generation effect, the present disclosure provides an image generation method. The method includes: first, obtaining noise to be processed, a time step sequence, a text feature of a target text, and an identity document (ID) feature of a target object in a first image, so that the time step sequence includes at least one first time step, at least one second time step, at least one third time step, and at least one fourth time step; next, processing the at least one first time step, the noise to be processed, and the text feature using a first denoising network to obtain a first result; next, processing the at least one second time step, the first result, the text feature, and the ID feature using a second denoising network to obtain a second result; subsequently, processing the at least one third time step, the second result, and the text feature using a third denoising network to obtain a third result; and finally, processing the at least one fourth time step, the third result, the text feature, and the ID feature using a fourth denoising network to obtain a second image, thereby meeting the aforementioned image generation requirements.

For a first stage implemented based on the processing process for the at least one first time step, as this first stage is implemented by means of the first denoising network, and the input data to the cross attention module within the first denoising network includes the text feature, the ID feature is not introduced in the first stage implemented by means of the first denoising network, so that the first result obtained using this first stage can accurately represent the overall image structure described by the target text as much as possible. Consequently, image generation processing can be performed in subsequent stages under the constraint of this overall image structure. This can effectively ensure that the overall image structure of the finally generated image remains consistent with the overall image structure described by the target text, thereby contributing to an improved editing capability and, in turn, an improved image generation effect.

In addition, for a second stage implemented based on the processing process for the at least one second time step, as this second stage is implemented by means of the second denoising network, and the input data to the cross attention module within the second denoising network includes the text feature and the ID feature, the ID feature can be timely introduced in the second stage implemented by means of the second denoising network, so that the target object described by the second result obtained using this second stage can align with the ID feature as much as possible. This can effectively avoid defects caused by introducing the ID feature too late, such as the ineffectiveness of the ID feature due to significant differences in the target object, thereby contributing to an improved ID feature retention capability and, in turn, an improved image generation effect.

Furthermore, for a third stage implemented based on the processing process for the at least one third time step, as this third stage is still implemented by means of the third denoising network, and the input data to the cross attention module within the third denoising network includes the text feature, the ID feature is no longer introduced in the third stage implemented by means of the third denoising network, so that the third stage can perform free generation without the constraint of the ID feature. Consequently, the third result obtained using the third stage can overcome or mitigate defects caused by the introduction of the ID feature in the second stage, such as unnatural transitions between the target object and its surrounding regions, thereby contributing to an improved image generation effect.

Moreover, for a fourth stage implemented based on the processing process for the at least one fourth time step, as this fourth stage is implemented by means of the fourth denoising network, and the input data to the self attention module within the fourth denoising network includes the ID feature and the input data to the cross attention module within the fourth denoising network includes the text feature, the fourth stage implemented by means of the fourth denoising network can correct the region where the target object in the image is located based on the ID feature. Consequently, the target object in the second image obtained using this fourth stage can possess identifying characteristics as similar as possible to those that the target object in the aforementioned first image possesses, thereby contributing to an improved ID feature retention capability and, in turn, an improved image generation effect.

The present disclosure does not impose limitations on the executing entity of the image generation method according to the embodiments of the present disclosure. For example, the image generation method provided in the embodiments of the present disclosure can be applied to a terminal device or a server. For another example, the image generation method according to the embodiments of the present disclosure can also be implemented by means of the data interaction process between the terminal device and the server. Herein, the terminal device may be a smartphone, a computer, a personal digital assistant (PDA) or a tablet. The server may be a stand-alone server, a cluster server, or a cloud server.

In order for persons skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by persons of ordinary skill in the art based on the embodiments of the present disclosure without creative efforts fall within the scope of protection of the present disclosure.

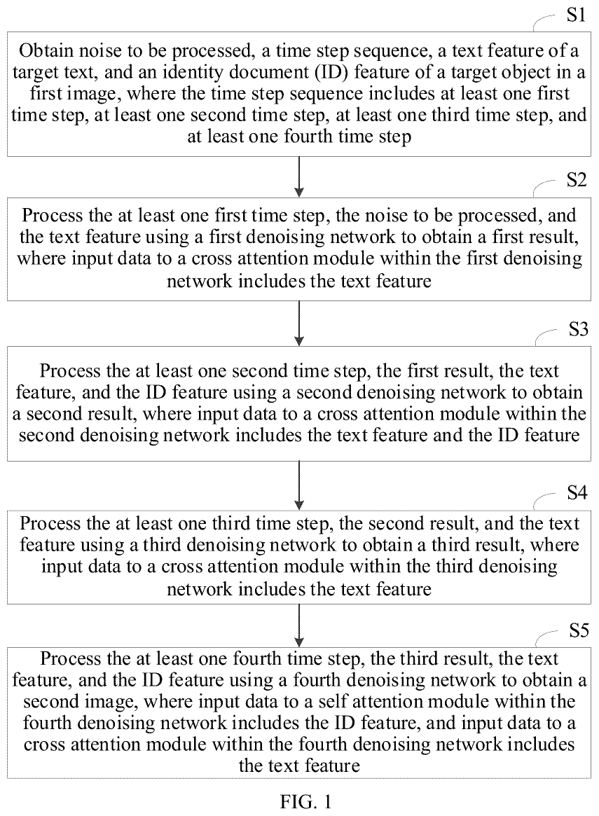

For a better understanding of the technical solution provided in the present disclosure, the image generation method provided in the present disclosure is first described below in conjunction with some drawings. As shown in FIG. 1, an image generation method according to an embodiment of the present disclosure includes the following S1 to S5. FIG. 1 is a flowchart of an image generation method according to an embodiment of the present disclosure.

S1: Obtain noise to be processed, a time step sequence, a text feature of a target text, and an identity document (ID) feature of a target object in a first image, where the time step sequence includes at least one first time step, at least one second time step, at least one third time step, and at least one fourth time step.

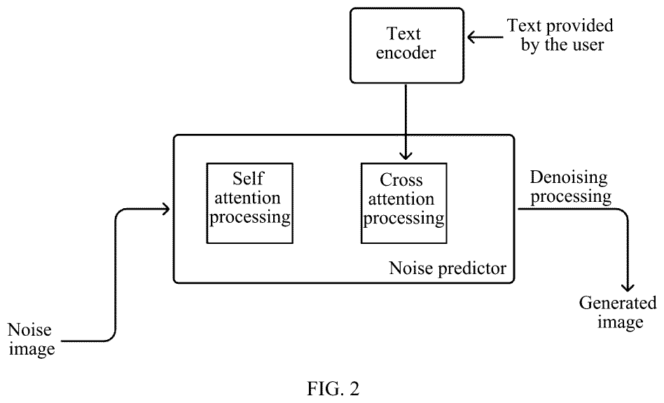

Here, the noise to be processed refers to a noise image required for use when performing image generation processing, such as a noise image shown in FIGS. 2-4, thereby enabling a plurality of times of denoising processing, such as denoising processing at a plurality of time steps, to be subsequently performed on the noise to be processed to obtain a new image, so that the new image can represent the denoising result for the noise to be processed.

In addition, the present disclosure does not impose limitations on the method for obtaining the noise to be processed. For instance, in some scenarios, the noise to be processed can be determined through a random generation method. For another example, in some scenarios, the process for obtaining the noise to be processed may be: performing noise addition processing on an image to obtain the noise to be processed. It should be noted that the present disclosure does not impose limitations on the implementation of the noise addition processing. For instance, it may be implemented using any existing or future method capable of performing noise addition processing on an image, such as a method implemented by means of a noise addition module within any diffusion model. The noise addition module is configured to add noise at a plurality of time steps to input data, such as an image, of the noise addition module, so that the noise addition module can implement a diffusion process, also known as a forward process.

The time step sequence refers to the plurality of time steps that need to be used sequentially when processing the noise to be processed, such as during denoising processing. For instance, the time step sequence can be the sequence of {Step_{T}, Step_{T-1}, Step_{T-3}, Step_{T-2}, . . . , Step₁}, so that the time steps Step_{T}, Step_{T-1}, Step_{T-3}, Step_{T-2}, . . . , and Step₁ are used sequentially when processing the noise to be processed.

In addition, the present disclosure does not impose limitations on the method for obtaining the aforementioned time step sequence. For instance, it can be set by relevant personnel in advance for the image generation process, such as being set during the construction of a corresponding denoising network.

Furthermore, to better balance the editing capability and the ID feature retention capability, the present disclosure provides a possible implementation of the aforementioned time step sequence. In this implementation, the time step sequence may include at least one first time step, at least one second time step, at least one third time step, and at least one fourth time step, thereby enabling four-stage image generation processing to be subsequently implemented by means of the time step sequence. Among them, the first time step refers to a time step used in the first stage; the second time step refers to a time step used in the second stage; the third time step refers to a time step used in the third stage; and the fourth time step refers to a time step used in the fourth stage.

It can be seen that, in a possible implementation, when the time step sequence includes at least one first time step, at least one second time step, at least one third time step, and at least one fourth time step, the time step sequence satisfies at least the following constraints: the usage time of each first time step precedes that of each second time step; the usage time of each second time step precedes that of each third time step; and the usage time of each third time step precedes that of each fourth time step. Here, for any given time step, the usage time of the time step refers to the time of occurrence of the processing process for that time step when performing image generation processing based on the noise to be processed.

Additionally, through research, it has been found that in order to further improve image generation effect, the present disclosure further provides a possible implementation of the aforementioned time step sequence. In this implementation, the time step sequence may further satisfy the following constraints: the ratio of the number of first time steps to the total number of time steps in the time step sequence is 1/6; the ratio of the number of second time steps to the total number of time steps in the time step sequence is 1/6; the ratio of the number of third time steps to the total number of time steps in the time step sequence is 1/6; and the ratio of the number of fourth time steps to the total number of time steps in the time step sequence is 1/2. This helps to ensure that the ID features are introduced at appropriate times, thereby helping to achieve a better balance between the editing capability and the ID feature retention capability, in order to address the defects where an overly strong editing capability results in a weak ID feature retention capability, or an overly strong ID feature retention capability compromises the editing capability. To facilitate understanding, the following will provide explanations in conjunction with examples.

As an example, when the time step sequence is the sequence of {Step₃₀, Step₂₉, Step₂₈, Step₂₇, . . . , Step₁} and the time step sequence includes at least one first time step, at least one second time step, at least one third time step, and at least one fourth time step, the at least one first time step may include the 5 time steps Step₃₀, Step₂₉, Step₂₈, Step₂₇, and Step₂₆; the at least one second time step may include the 5 time steps Step₂₅, Step₂₄, Step₂₃, Step₂₂, and Step₂₁; the at least one third time step may include the 5 time steps Step₂₀, Step₁₉, Stepis, Step₁₇, and Step₁₆; and the at least one fourth time step may include the 15 time steps Step₁₅, Step₁₄, Step₁₃, . . . , and Step₁.

The target text refers to a text provided by the user, such as the text “a photo of a man and a dog” or text shown in FIGS. 2-4, so that the target text can express the user's image generation requirements, such as requirements in the aspects like the overall image structure, thereby enabling a new image that meets the image generation requirements to be subsequently generated based on the target text. It can be seen that, in a possible implementation, the target text may refer to a text provided by the user by means of certain input devices to describe the image generation requirements.

The text feature of the target text is used to represent the information carried by the target text, such as semantic information. Moreover, the text feature is obtained by performing text feature extraction processing on the target text.

Additionally, the present disclosure does not impose limitations on the implementation of the text feature extraction processing described in the preceding paragraph. For instance, the text feature extraction processing can be implemented by means of a pre-constructed text encoder, such as the text encoders shown in FIGS. 2-4. The text encoder is configured to perform text encoding processing or text feature extraction processing on the input data to the text encoder. It can be seen that, in a possible implementation, the text feature of the aforementioned target text is obtained by the text encoder performing encoding processing on the target text.

Additionally, the present disclosure does not impose limitations on the implementation of the text encoder described in the preceding paragraph. For instance, it may be implemented using any existing or future encoder capable of performing encoding processing on text, such as a text encoder in any diffusion model.

The first image refers to an image provided by the user, so that this first image can represent the user's generation requirements for a target object (such as the face, head, or upper body), such as the requirements regarding what kind of identifying characteristics that some or all of the individuals in the generated new image should possess on the target object, thereby enabling a new image that meets the target object generation requirements to be subsequently generated based on the first image. It can be seen that, in a possible implementation, the first image may refer to an image provided by the user by means of certain input devices to describe the target object generation requirements. Moreover, there is at least one target object present in this first image.

It should be noted that the present disclosure does not impose limitations on the implementation of the target object. For instance, in some scenarios, such as face-constrained scenarios, the target object can be the face. For another example, in some scenarios, such as head-constrained scenarios, the target object can be the head. For yet another example, in some scenarios, such as upper body-constrained scenarios, the target object can be the upper body. Furthermore, in some scenarios, such as full body-constrained scenarios, the target object can be the full body.

The ID feature of the target object in the first image is used to represent the identifying characteristics that the target object in the first image possesses, such as the contour of the target object and the distribution of various parts (e.g., parts such as facial features) in the target object. Moreover, the ID feature is obtained by performing ID feature extraction processing on the first image.

Additionally, the present disclosure does not impose limitations on the implementation of the ID feature extraction processing described in the preceding paragraph. For instance, the ID feature extraction processing can be implemented by means of a pre-constructed ID feature extraction module. The ID feature extraction module is configured to perform ID feature extraction processing on input data to the ID feature extraction module. It can be seen that in a possible embodiment, the ID feature of the target object in the first image is obtained by processing the first image through the ID feature extraction module.

Furthermore, the present disclosure does not impose limitations on the implementation of the ID feature extraction module described in the preceding paragraph. For instance, the ID feature extraction module can be implemented using any existing or future method capable of performing feature extraction processing on an image, for example, by means of a module similar to the one based on contrastive language-image pre-training (CLIP), which is capable of performing image feature extraction processing.

In practice, to further improve the accuracy of the ID feature, the present disclosure further provides a possible implementation of the aforementioned ID feature extraction module. In this implementation, the ID feature extraction module may include a multi-layer feature extraction module and a feature fusion module. Moreover, input data to the feature fusion module includes part or all of output data from the multi-layer feature extraction module.

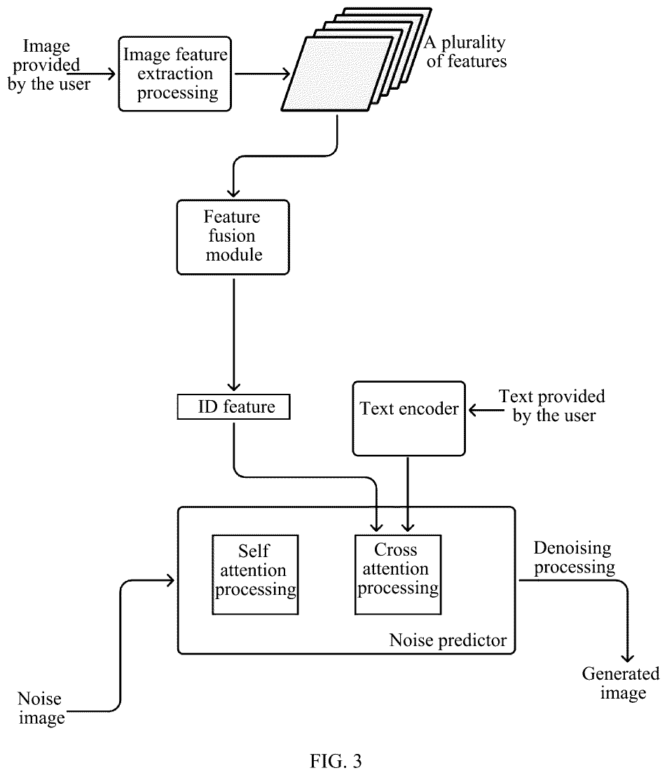

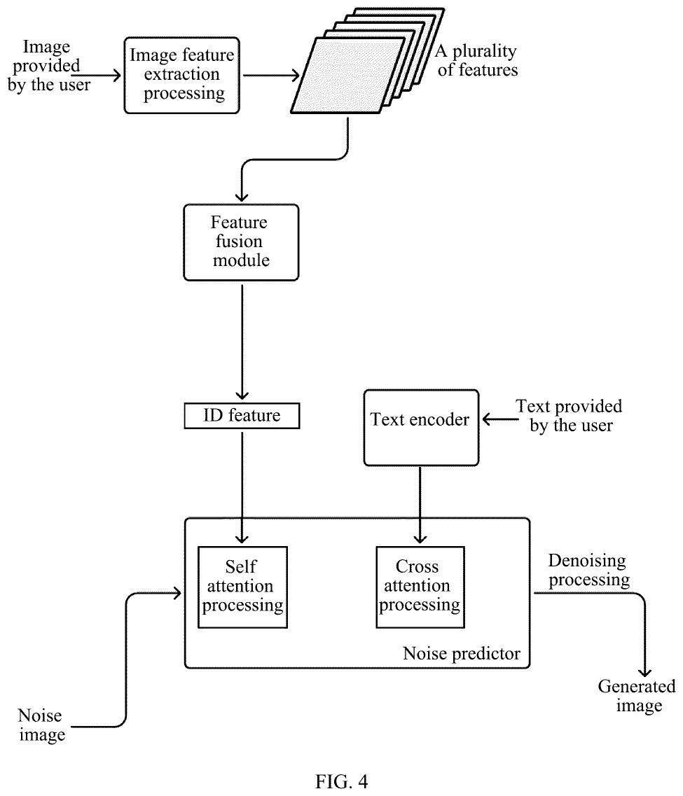

The multi-layer feature extraction module is configured to extract image features of a plurality of sizes from an image, such as pyramid features, the plurality of features shown in FIG. 3, or the plurality of features shown in FIG. 4, so that these image features can comprehensively and accurately describe the information carried in the image to the greatest extent possible. Additionally, the present disclosure does not impose limitations on the implementation of the multi-layer feature extraction module. For instance, the multi-layer feature extraction module can be implemented using CLIP.

The feature fusion module is configured to fuse image features of different sizes into a single feature, so that the fused feature can more accurately represent the identifying characteristics that the target object in the image possesses. Additionally, the present disclosure does not impose limitations on the implementation of the feature fusion module. For instance, when the output data of the aforementioned multi-layer feature extraction module includes image features of a plurality of sizes, the feature fusion module can be configured to perform fusion processing on image features of some or all of these different sizes, such as performing fusion processing on image features of five sizes. Additionally, the present disclosure does not impose limitations on the structure of the feature fusion module. For example, the feature fusion module can be implemented using a two-layer neural network.

It can be seen that, since the feature fusion module is configured to extract ID features from image features of a plurality of sizes, and since image features of different sizes carry different information, the extracted ID features can more accurately describe the identifying characteristics that the target object in the image possesses, thereby contributing to an improved accuracy of the ID features. Moreover, because the feature fusion module can fuse image features of a plurality of sizes into a single feature, subsequent corresponding processing only needs to be performed based on this single feature. This can effectively overcome the defects caused by size inconsistencies when processing image features of a plurality of sizes, such as increased data processing difficulty, increased processing time overhead, higher computing resource overhead, and an increased number of relevant parameters in subsequent processing modules.

S2: Process the at least one first time step, the noise to be processed, and the text feature using a first denoising network to obtain a first result, where input data to a cross attention module within the first denoising network includes the text feature.

The first denoising network refers to a denoising network required for use when performing image generation processing with a text as a constraint condition, enabling the first denoising network to utilize the text feature of the text through cross attention processing.

In a possible implementation, when the first stage is implemented using the first denoising network, and the first stage includes N₁ first time steps, where N₁ is a positive integer, for example, N₁=5, the implementation process of the first stage is as follows.

First, the first denoising network processes a 1^{st} first time step, the noise to be processed, and the text feature of the aforementioned target text to obtain a denoising result corresponding to the 1^{st} first time step, enabling the “denoising result corresponding to the 1^{st} first time step” to represent the state presented after removing noise corresponding to the 1^{st} first time step.

Next, the first denoising network processes a 2^{nd} first time step, the “denoising result corresponding to the 1^{st} first time step,” and the text feature of the aforementioned target text to obtain a denoising result corresponding to the 2^{nd} first time step, enabling the “denoising result corresponding to the 2^{nd} first time step” to represent the state presented after removing noise corresponding to the first two first time steps.

Then, the first denoising network processes a 3^{rd} first time step, the “denoising result corresponding to the 2^{nd} first time step,” and the text feature of the aforementioned target text to obtain a denoising result corresponding to the 3^{rd} first time step, enabling the “denoising result corresponding to the 3^{rd} first time step” to represent the state presented after removing noise corresponding to the first three first time steps.

### . . . (And so on.)

Finally, the first denoising network processes an N₁^{th} first time step, a denoising result corresponding to an (N₁−1)^{th} first time step, and the text feature of the aforementioned target text to obtain a denoising result corresponding to the N₁^{th} first time step, enabling the “denoising result corresponding to the N₁^{th} first time step” to represent the state presented after removing noise corresponding to all the first time steps. This enables the “denoising result corresponding to the N₁^{th} first time step” to represent an image obtained after undergoing the first stage, so that the overall image structure presented in the image is as close as possible to the overall image structure described by the target text, thereby contributing to an improved editing capability.

It should be noted that, for any given time step, the denoising result corresponding to that time step may refer to either a noise image or a feature map of the noise image. The present disclosure does not impose any limitations on this and allows for flexible settings based on the actual application scenario.

Additionally, for an n₁^{th} first time step, when the n₁^{th} first time step is processed using the first denoising network, the input data to the cross attention module within the first denoising network may include the text feature of the aforementioned target text, enabling the cross attention module to perform cross attention processing on the text feature and a feature map input to the cross attention module. The “feature map input to the cross attention module” refers to a feature map received by the cross attention module when the n₁^{th} first time step is processed using the first denoising network, for example, a feature map provided to the cross attention module by other modules, such as a self attention module, during the processing by the first denoising network, or alternatively, a feature map of a noise image corresponding to the n₁^{th} first time step, and the like. Here, n₁ is a positive integer, with n₁≤N₁.

In addition, for the aforementioned n₁^{th} first time step, the noise image corresponding to the n₁^{th} first time step refers to the noise image involved when the n₁^{th} first time step is processed using the first denoising network. When n₁=1, the noise image corresponding to the n₁^{th} first time step is the aforementioned noise to be processed; when n₁≥2, and the denoising result corresponding to the aforementioned (n₁−1)^{th} first time step is a noise image, the noise image corresponding to the n₁^{th} first time step may be the denoising result corresponding to the (n₁−1)^{th} first time step.

Furthermore, for the aforementioned n₁^{th} first time step, a feature map corresponding to the n₁^{th} first time step refers to a feature map for the noise image corresponding to the n₁^{th} first time step, so that the “feature map corresponding to the n₁^{th} first time step” is used to represent the information carried by the noise image corresponding to the n₁^{th} first time step. It should be noted that the present disclosure does not impose limitations on the implementation of the “feature map corresponding to the n₁^{th} first time step”. For instance, the “feature map corresponding to the n₁^{th} first time step” may be obtained by performing image feature extraction processing on the noise image corresponding to the n₁^{th} first time step. For another example, when n₁≥2, and the denoising result corresponding to the aforementioned (n₁−1)^{th} first time step is a noise image, the “feature map corresponding to the n₁^{th} first time step” may be obtained during the generation process of the aforementioned “denoising result corresponding to the (n₁−1)^{th} first time step”. For yet another example, when n₁≥2, and the “denoising result corresponding to the (n₁−1)^{th} first time step” is a feature map, the “feature map corresponding to the n₁^{th} first time step” may be implemented using the “denoising result corresponding to the (n₁−1)^{th} first time step”.

It can be seen that, in a possible implementation, for any first time step among the aforementioned at least one first time step, a noise image corresponding to the first time step is determined based on the first time step and the noise to be processed, thereby allowing the feature map corresponding to the first time step to be used to describe the information carried by the noise image corresponding to the first time step.

Furthermore, the present disclosure does not impose limitations on the implementation of the aforementioned first denoising network. For instance, it may be implemented using a denoising network in any existing or future diffusion model capable of performing image generation processing based on a text.

To further improve the image generation effect, the present disclosure further provides a possible implementation of the aforementioned first denoising network. In this implementation, for any first time step, the cross attention module within the first denoising network is configured to perform cross attention processing based on the text feature of the aforementioned target text and the feature map corresponding to the first time step, thereby contributing to an improved degree of constraint imposed by the target text on the image generation process.

The cross attention module within the first denoising network only introduces the constraint condition of the text feature of the target text, so that the first stage implemented based on the first denoising network is not constrained by the ID feature, thereby enabling the first stage to effectively construct the overall image structure described by the target text. Consequently, this can effectively avoid the defect that arises when the ID feature is directly introduced in the first stage, where the excessive interference of the ID feature prevents the construction of the overall image structure described by the target text, thereby contributing to an improved editing capability.

To further improve the image generation effect, the present disclosure further provides a possible implementation of the aforementioned first denoising network. In this implementation, the first denoising network may include at least a first noise predictor, such as the noise predictor shown in FIG. 2, and the cross attention module within the first denoising network includes the cross attention module within the first noise predictor.

For the first noise predictor described in the preceding paragraph, such as the noise predictor shown in FIG. 2, the first noise predictor refers to a module present in the first denoising network that is configured to perform noise prediction processing for a single time step, such as a Unet. Furthermore, the cross attention module within the first noise predictor is capable of utilizing the text feature of the aforementioned target text through cross attention processing. It can be seen that the cross attention module within the first noise predictor only introduces the constraint condition of the text feature, so that the first stage implemented based on the first noise predictor is not constrained by the ID feature, thereby contributing to an improved editing capability. It should be noted that the present disclosure does not impose limitations on the implementation of the first noise predictor. For instance, it may be implemented using the noise predictor shown in FIG. 2.

To further improve the image generation effect, the present disclosure further provides a possible implementation of the aforementioned first denoising network. In this implementation, the first denoising network may be a denoising network in a first diffusion model, where the first diffusion model is configured to perform image generation processing with a text as a constraint condition.

Additionally, the present disclosure does not impose limitations on the implementation of the first diffusion model. For instance, the first diffusion model may be implemented using any existing or future diffusion model capable of performing image generation processing with a text as a constraint condition. For another example, in some scenarios, the first diffusion model may include a text encoder and a first denoising network, and input data to a cross attention module within the first denoising network includes output data from the text encoder. For details regarding the text encoder, reference can be made to the aforementioned content.

In addition, the present disclosure does not impose limitations on the method for obtaining the first diffusion model. For instance, it may be implemented using any existing or future method capable of constructing or training a diffusion model that has the functionality of performing image generation processing with a text as a constraint condition.

The aforementioned first result refers to some data obtained by using the first denoising network in the aforementioned at least one first time step, for example, data such as the denoising result corresponding to the last first time step, enabling the first result to represent data obtained through the first stage.

Additionally, the present disclosure does not impose limitations on the implementation of the aforementioned first result. For instance, when the first stage includes N₁ first time steps, the first result may at least include the aforementioned “denoising result corresponding to the N₁^{th} first time step”, thereby enabling a second stage, such as a second stage shown in S3 below, to be subsequently executed based on the “denoising result corresponding to the N₁^{th} first time step”.

To minimize the impact of the image provided by the user on regions other than the target object, the present disclosure further provides an implementation of the aforementioned first result. In this implementation, when the target text includes a target entity and the target entity belongs to a preset entity type, the first result may further include an attention map of the target entity, with the attention map being used to describe an image region where the target entity is located.

The target entity refers to an entity present in the aforementioned target text that belongs to a preset entity type, so that the target entity can represent an entity present in the target text that requires target object constraint based on the ID feature of the image provided by the user, such as the entity “man”. The preset entity type refers to the type to which an entity requiring target object constraint based on the ID feature of the image provided by the user belong. Furthermore, the preset entity type may be set in advance based on actual application scenarios or set by the user by certain means, which is not limited in the present disclosure. For instance, the preset entity type may refer to the type “person”.

Additionally, the present disclosure does not impose limitations on the process of determining the target entity. For instance, the determining may include: first performing entity recognition processing on the target text to obtain an entity recognition result, so that the entity recognition result can indicate which entities are present in the target text; and then determining a target entity belonging to the preset entity type based on the entity recognition result. It should be noted that the present disclosure does not impose limitations on the implementation of the entity recognition processing.

In addition, in some scenarios, there may be a plurality of entities present in the target text that belong to the preset entity type. Therefore, to improve the image generation effect, the present disclosure further provides a method for determining the target entity. In this method, the process of determining the target entity may include: first performing entity recognition processing on the target text to obtain a plurality of candidate entities, so that each of the candidate entities belongs to the preset entity type; then searching for a target entity that matches the first image from among the plurality of candidate entities. It should be noted that the present disclosure does not impose limitations on the implementation of the matching. For instance, the matching refers to a high degree of similarity between information carried by the target entity and target object information described in the first image. For another example, the matching may also refer to a high degree of similarity between the target entity and the annotation content corresponding to the first image. Here, the annotation content is at least used to describe the attributes of the applicable group of people for the target object in the first image.

Furthermore, for the target entity, the attention map of the target entity is obtained when performing attention processing, such as cross attention processing, based on the text feature of the target text, so that the “attention map of the target entity” can represent the image region where the target entity is located, such as the region where the target entity is located in certain feature maps or certain images. This enables some local processing to be subsequently performed on the image region where the target entity is located based on the “attention map of the target entity”, thereby effectively reducing the impact of the image provided by the user on regions other than the target object.

Based on the relevant content of the aforementioned S2, it can be seen that for the first stage provided in the present disclosure, when the first stage includes N₁ first time steps, the first stage can be as follows: first, processing a 1^{st} first time step, the noise to be processed, and the text feature of the aforementioned target text using the first denoising network to at least obtain a denoising result corresponding to the 1^{st} first time step; next, processing a 2^{nd} first time step, the denoising result corresponding to the 1^{st} first time step, and the text feature using the first denoising network to at least obtain a denoising result corresponding to the 2^{nd} first time step; . . . (and so on); finally, processing an N₁^{th} first time step, a denoising result corresponding to an (N₁−1)^{th} first time step, and the text feature using the first denoising network to obtain the aforementioned first result, such as a denoising result corresponding to the N₁^{th} first time step, and an attention map of the aforementioned target entity, thereby enabling the following second stage to be subsequently executed based on the first result.

S3: Process the at least one second time step, the first result, the text feature, and the ID feature using a second denoising network to obtain a second result, where input data to a cross attention module within the second denoising network includes the text feature and the ID feature.

The second denoising network refers to a denoising network required for use when performing image generation processing with a text and an image as constraint conditions, enabling the second denoising network to utilize the text feature of the text and the ID feature of the target object in the image through cross attention processing.

In a possible implementation, if the aforementioned first result at least includes the denoising result corresponding to the N₁^{th} first time step, when the second stage is implemented using the second denoising network, and the second stage includes N₂ second time steps, where N₂ is a positive integer, for example, N₂=5, the implementation process of the second stage is as follows.

First, the second denoising network processes a 1^{st} second time step, the aforementioned “denoising result corresponding to the N₁^{th} first time step”, the text feature of the aforementioned target text, and the ID feature of the target object in the aforementioned first image to obtain a denoising result corresponding to the 1^{st} second time step, enabling the “denoising result corresponding to the 1^{st} second time step” to represent the state presented after removing noise corresponding to the aforementioned N₁ first time steps and the 1^{st} second time step.

Next, the second denoising network processes a 2^{nd} second time step, the aforementioned “denoising result corresponding to the 1^{st} second time step”, the text feature of the aforementioned target text, and the ID feature of the target object in the aforementioned first image to obtain a denoising result corresponding to the 2^{nd} second time step, enabling the “denoising result corresponding to the 2^{nd} second time step” to represent the state presented after removing noise corresponding to the aforementioned N₁ first time steps and the first two second time steps.

Then, the second denoising network processes a 3^{rd} second time step, the aforementioned “denoising result corresponding to the 2^{nd} second time step”, the text feature of the aforementioned target text, and the ID feature of the target object in the aforementioned first image to obtain a denoising result corresponding to the 3^{rd} second time step, enabling the “denoising result corresponding to the 3^{rd} second time step” to represent the state presented after removing noise corresponding to the aforementioned N₁ first time steps and the first three second time steps.

### . . . (And so on.)

Finally, the second denoising network processes an N₂^{th} second time step, the denoising result corresponding to the (N₂−1)^{th} second time step, the text feature of the aforementioned target text, and the ID feature of the target object in the aforementioned first image to obtain a denoising result corresponding to the N₂^{th} second time step, enabling the “denoising result corresponding to the N₂^{th} second time step” to represent the state presented after removing noise corresponding to all the first time steps and all the second time steps. This enables the “denoising result corresponding to the N₂^{th} second time step” to represent an image obtained after undergoing the first two stages, so that the overall image structure presented in the image is as close as possible to the overall image structure described by the target text, while the identifying characteristics presented by the target object in the image are as close as possible to the identifying characteristics described by the ID feature, thereby contributing to an improved ID feature retention capability.

Additionally, for an n₂^{th} second time step, when the n₂^{th} second time step is processed using the second denoising network, the input data to the cross attention module within the second denoising network may include the text feature of the aforementioned target text and the ID feature of the target object in the aforementioned first image, enabling the cross attention module to perform cross attention processing on the text feature, the ID feature, and a feature map input to the cross attention module. The “feature map input to the cross attention module” refers to a feature map received by the cross attention module when the n₂^{th} second time step is processed using the second denoising network, for example, a feature map provided to the cross attention module by other modules, such as a self attention module, during the processing by the second denoising network, or alternatively, a feature map of a noise image corresponding to the n₂^{th} second time step, and the like. Here, n₂ is a positive integer, with n₂≤N₂.

In addition, for the aforementioned n₂^{th} second time step, the noise image corresponding to the n₂^{th} second time step refers to the noise image involved when the n₂^{th} second time step is processed using the second denoising network. When n₂=1, and the aforementioned “denoising result corresponding to the N₁^{th} first time step” is a noise image, the noise image corresponding to the n₂^{th} second time step may be the “denoising result corresponding to the N₁^{th} first time step”; when n₂≥2, and the denoising result corresponding to an (n₂−1)^{th} second time step is a noise image, the noise image corresponding to the n₂^{th} second time step may be the “denoising result corresponding to the (n₂−1)^{th} second time step”.

Furthermore, for the aforementioned n₂^{th} second time step, a feature map corresponding to the n₂^{th} second time step refers to a feature map for the noise image corresponding to the n₂^{th} second time step, so that the “feature map corresponding to the n₂^{th} second time step” is used to represent the information carried by the noise image corresponding to the n₂^{th} second time step. It should be noted that the present disclosure does not impose limitations on the implementation of the “feature map corresponding to the n₂^{th} second time step”. For instance, the “feature map corresponding to the n₂^{th} second time step” may be obtained by performing image feature extraction processing on the noise image corresponding to the n₂^{th} second time step. For another example, when n₂≥2, and the denoising result corresponding to the aforementioned (n₂−1)^{th} second time step is a noise image, the “feature map corresponding to the n₂^{th} second time step” may be obtained during the generation process of the aforementioned “denoising result corresponding to the (n₂−1)^{th} second time step”. For yet another example, when n₂≥2, and the “denoising result corresponding to the (n₂−1)^{th} second time step” is a feature map, the “feature map corresponding to the n₂^{th} second time step” may be implemented using the “denoising result corresponding to the (n₂−1)^{th} second time step”.

In a possible implementation, for any second time step among the aforementioned at least one second time step, a noise image corresponding to the second time step is determined based on the second time step and the aforementioned first result, thereby allowing the feature map corresponding to the second time step to be used to describe the information carried by the noise image corresponding to the second time step.

Furthermore, the present disclosure does not impose limitations on the implementation of the aforementioned second denoising network. For instance, it may be implemented using a denoising network in any existing or future diffusion model capable of performing image generation processing based on a text and an image.

To further improve the image generation effect, the present disclosure further provides a possible implementation of the aforementioned second denoising network. In this implementation, for any second time step, the cross attention module within the second denoising network is configured to: perform cross attention processing based on the text feature of the aforementioned target text, the ID feature of the target object in the aforementioned first image, and the feature map corresponding to the second time step. This contributes to an improved degree of constraint imposed by the first image on the generation of the target object.

The cross attention module within the second denoising network simultaneously introduces two constraint conditions of the text feature of the target text and the ID feature of the target object in the aforementioned first image, so that the second stage implemented based on the second denoising network performs ID feature constraint through cross attention processing, thereby enabling the second stage to timely adjust the target object based on the ID feature. Consequently, this can effectively avoid defects caused by introducing the ID feature too late or too early, thereby contributing to an improved ID feature retention capability.

To minimize the impact of the image provided by the user on regions other than the target object, the present disclosure further provides a possible implementation of the aforementioned second denoising network. In this implementation, when the aforementioned first result further includes the attention map of the target entity, which is used to describe the image region where the target entity is located, for any second time step, the cross attention module within the second denoising network is configured to: process the image region in the feature map corresponding to the second time step based on the ID feature of the target object in the aforementioned first image, and process regions other than the image region in the feature map corresponding to the second time step based on the text feature of the aforementioned target text. This can ensure, as much as possible, that the ID feature is used exclusively to constrain the region where the target object is located, thereby effectively reducing the impact of the image provided by the user on regions other than the target object.

In practice, to further improve the image generation effect, the present disclosure further provides a possible implementation of the aforementioned second denoising network. In this implementation, the second denoising network may include at least a second noise predictor, such as the noise predictor shown in FIG. 3, and the cross attention module within the second denoising network includes the cross attention module within the second noise predictor.

For the second noise predictor described in the preceding paragraph, such as the noise predictor shown in FIG. 3, the second noise predictor refers to a module present in the second denoising network that is configured to perform noise prediction processing for a single time step, such as a Unet. Furthermore, the cross attention module within the second noise predictor is capable of utilizing the text feature of the aforementioned target text and the ID feature of the target object in the aforementioned first image through cross attention processing. It can be seen that the cross attention module within the second noise predictor simultaneously introduces the two constraint conditions of the text feature and the ID feature, so that the second stage implemented based on the second noise predictor is constrained by the ID feature, thereby contributing to an improved ID feature retention capability. It should be noted that the present disclosure does not impose limitations on the implementation of the second noise predictor. For instance, it may be implemented using the noise predictor shown in FIG. 3.

In practice, to further improve the image generation effect, the present disclosure further provides a possible implementation of the aforementioned second denoising network. In this implementation, the second denoising network may be a denoising network in a second diffusion model, where the second diffusion model is configured to perform image generation processing, such as cross attention processing, with a text and an image as constraint conditions.

Additionally, the present disclosure does not impose limitations on the implementation of the second diffusion model. For instance, the second diffusion model may be implemented using any existing or future diffusion model capable of performing cross attention processing with a text and an image as constraint conditions. For another example, in some scenarios, the second diffusion model may include a text encoder, an ID feature extraction module, and a second denoising network, and input data to a cross attention module within the second denoising network includes output data from the text encoder and output data from the ID feature extraction module. For details regarding the text encoder and the ID feature extraction module, reference can be made to the aforementioned content.

In addition, the present disclosure does not impose limitations on the method for obtaining the second diffusion model. For instance, it may be implemented using any existing or future method capable of constructing or training a diffusion model that has the functionality of performing cross attention processing with a text and an image as constraint conditions.

The aforementioned second result refers to some data obtained by using the second denoising network in the aforementioned at least one second time step, for example, data such as the denoising result corresponding to the last second time step, enabling the second result to represent data obtained through the first two stages.

Additionally, the present disclosure does not impose limitations on the implementation of the aforementioned second result. For instance, when the second stage includes N₂ second time steps, the second result may at least include the aforementioned “denoising result corresponding to the N₂^{th} second time step”, thereby enabling a third stage, such as a third stage shown in S4 below, to be subsequently executed based on the “denoising result corresponding to the N₂^{th} second time step”.

Based on the relevant content of the aforementioned S3, it can be seen that for the second stage provided in the present disclosure, when the second stage includes N₂ second time steps, the second stage can be as follows: first, processing the 1^{st} second time step, the denoising result corresponding to the aforementioned N₁^{th} first time step, the attention map of the aforementioned target entity, the text feature of the aforementioned target text, and the ID feature of the target object in the aforementioned first image using the second denoising network to obtain a denoising result corresponding to the 1^{st} second time step, among others; next, processing a 2^{nd} second time step, the denoising result corresponding to the 1^{st} second time step, the attention map, the text feature, and the ID feature using the second denoising network to obtain a denoising result corresponding to the 2^{nd} second time step, among others; . . . (and so on); finally, processing an N₂^{th} second time step, the denoising result corresponding to the (N₂−1)^{th} second time step, the attention map, the text feature, and the ID feature using the second denoising network to obtain the aforementioned second result, such as a denoising result corresponding to the N₂^{th} second time step, thereby enabling the following third stage to be subsequently executed based on the second result.

S4: Process the at least one third time step, the second result, and the text feature using a third denoising network to obtain a third result, where input data to a cross attention module within the third denoising network includes the text feature.

The third denoising network refers to a denoising network required for use when performing image generation processing with a text as a constraint condition, enabling the third denoising network to utilize the text feature of the text through cross attention processing.

It can be seen that, in a possible implementation, when the third stage is implemented using the third denoising network, and the third stage includes N₃ third time steps, where N₃ is a positive integer, for example, N₃=5, the implementation process of the third stage is as follows.

First, the third denoising network processes a 1^{st} third time step, the second result, and the text feature of the aforementioned target text to obtain a denoising result corresponding to the 1^{st} third time step, enabling the “denoising result corresponding to the 1^{st} third time step” to represent the state presented after removing noise corresponding to all the first time steps, all the second time steps, and the 1^{st} third time step.

Next, the third denoising network processes a 2^{nd} third time step, the “denoising result corresponding to the 1^{st} third time step”, and the text feature of the aforementioned target text to obtain a denoising result corresponding to the 2^{nd} third time step, enabling the “denoising result corresponding to the 2^{nd} third time step” to represent the state presented after removing noise corresponding to all the first time steps, all the second time steps, and the first two third time steps.

Then, the third denoising network processes a 3^{rd} third time step, the “denoising result corresponding to the 2^{nd} third time step”, and the text feature of the aforementioned target text to obtain a denoising result corresponding to the 3^{rd} third time step, enabling the “denoising result corresponding to the 3^{rd} third time step” to represent the state presented after removing noise corresponding to all the first time steps, all the second time steps, and the first three third time steps.

. . . (and so on.)

Finally, the third denoising network processes an N₃^{th} third time step, the “denoising result corresponding to the (N₃−1)^{th} third time step”, and the text feature of the aforementioned target text to obtain a denoising result corresponding to the N₃^{th} third time step, enabling the “denoising result corresponding to the Nath third time step” to represent the state presented after removing noise corresponding to all the first time steps, all the second time steps, and all the third time steps. This enables the “denoising result corresponding to the N₃^{th} third time step” to represent an image obtained after undergoing the first three stages, so that the information presented in the image is as close as possible to the information described by the target text, thereby contributing to an improved editing capability.

Additionally, for an n₃^{th} third time step, when the n₃^{th} third time step is processed using the third denoising network, the input data to the cross attention module within the third denoising network may include the text feature of the aforementioned target text, enabling the cross attention module to perform cross attention processing on the text feature and a feature map input to the cross attention module. The “feature map input to the cross attention module” refers to a feature map received by the cross attention module when the n₃^{th} third time step is processed using the third denoising network, for example, a feature map provided to the cross attention module by other modules, such as a self attention module, during the processing by the third denoising network, or alternatively, a feature map of a noise image corresponding to the n₃^{th} third time step, and the like. Here, n₃ is a positive integer, with n₃≤N₃.

In addition, for the aforementioned n₃^{th} third time step, the noise image corresponding to the n₃^{th} third time step refers to the noise image involved when the n₃^{th} third time step is processed using the third denoising network. When n₃₌₁, and the aforementioned “denoising result corresponding to the N₂^{th} second time step” is a noise image, the noise image corresponding to the n₃^{th} third time step may be the “denoising result corresponding to the N₂^{th} second time step”; when n₃≥2, and the denoising result corresponding to the (n₃−1)^{th} third time step is a noise image, the noise image corresponding to the n₃^{th} third time step may be the “denoising result corresponding to the (n₃−1)^{th} third time step”. Here, n₃ is a positive integer, with n₃≤N₃, where N₃ represents the number of third time steps, and N₃ is a positive integer, for example, N₃=5.

Furthermore, for the aforementioned n₃^{th} third time step, a feature map corresponding to the n₃^{th} third time step refers to a feature map for the noise image corresponding to the n₃^{th} third time step, so that the “feature map corresponding to the n₃^{th} third time step” is used to represent the information carried by the noise image corresponding to the n₃^{th} third time step. It should be noted that the present disclosure does not impose limitations on the implementation of the “feature map corresponding to the n₃^{th} third time step”. For instance, the “feature map corresponding to the n₃^{th} third time step” may be obtained by performing image feature extraction processing on the noise image corresponding to the n₃^{th} third time step. For another example, when n₃≥2, and the denoising result corresponding to the aforementioned (n₃−1)^{th} third time step is a noise image, the “feature map corresponding to the n₃^{th} third time step” may be obtained during the generation process of the “denoising result corresponding to the (n₃−1)^{th} third time step”. For yet another example, when n₃≥2, and the “denoising result corresponding to the aforementioned (n₃−1)^{th} third time step” is a feature map, the “feature map corresponding to the n₃^{th} third time step” may be implemented using the “denoising result corresponding to the (n₃−1)^{th} third time step”.

In a possible implementation, for any third time step among the aforementioned at least one third time step, a noise image corresponding to the third time step is determined based on the third time step and the aforementioned second result, thereby allowing the feature map corresponding to the third time step to be used to describe the information carried by the noise image corresponding to the third time step.

Furthermore, the present disclosure does not impose limitations on the implementation of the aforementioned third denoising network. For instance, it may be implemented using a denoising network in any existing or future diffusion model capable of performing image generation processing based on a text.

To further improve the image generation effect, the present disclosure further provides a possible implementation of the aforementioned third denoising network. In this implementation, for any third time step, the cross attention module within the third denoising network is configured to perform cross attention processing based on the text feature of the aforementioned target text and the feature map corresponding to the third time step, thereby contributing to an improved degree of constraint imposed by the target text on the image generation process.

The cross attention module within the third denoising network introduces only the constraint condition of the text feature of the target text, so that the third stage implemented based on the third denoising network is not constrained by the ID feature, thereby enabling the third stage to adjust the overall image region based on the text feature. Consequently, this can effectively eliminate or mitigate, as much as possible, content generated in the second stage that does not conform to the text feature, thereby contributing to an improved editing capability.

To further improve the image generation effect, the present disclosure further provides a possible implementation of the aforementioned third denoising network. In this implementation, the third denoising network may include at least a third noise predictor, and the cross attention module within the third denoising network includes the cross attention module within the third noise predictor.

For the third noise predictor described in the preceding paragraph, the third noise predictor refers to a module present in the third denoising network that is configured to perform noise prediction processing for a single time step, such as a Unet. Furthermore, the cross attention module within the third noise predictor is capable of utilizing the text feature of the aforementioned target text through cross attention processing. It can be seen that the cross attention module within the third noise predictor only introduces the constraint condition of the text feature, so that the third stage implemented based on the third noise predictor is not constrained by the ID feature, thereby contributing to an improved editing capability. It should be noted that the present disclosure does not impose limitations on the implementation of the third noise predictor. For instance, it may be implemented using the noise predictor shown in FIG. 2.

To further improve the image generation effect, the present disclosure further provides a possible implementation of the aforementioned third denoising network. In this implementation, the third denoising network may be a denoising network in a third diffusion model, where the third diffusion model is configured to perform image generation processing with a text as a constraint condition.

Additionally, the present disclosure does not impose limitations on the implementation of the third diffusion model. For instance, the third diffusion model may be implemented using any existing or future diffusion model capable of performing image generation processing with a text as a constraint condition. For another example, in some scenarios, the third diffusion model may include a text encoder and a third denoising network, and input data to a cross attention module within the third denoising network includes output data from the text encoder. For details regarding the text encoder, reference can be made to the aforementioned content.

In addition, the present disclosure does not impose limitations on the method for obtaining the third diffusion model. For instance, it may be implemented using any existing or future method capable of constructing or training a diffusion model that has the functionality of performing image generation processing with a text as a constraint condition.

The aforementioned third result refers to some data obtained by using the third denoising network in the aforementioned at least one third time step, for example, data such as the denoising result corresponding to the last third time step, enabling the third result to represent data obtained through the third stage.

Additionally, the present disclosure does not impose limitations on the implementation of the aforementioned third result. For instance, when the third stage includes N₃ third time steps, the third result may at least include the aforementioned “denoising result corresponding to the N₃^{th} third time step”, thereby enabling a fourth stage, such as a fourth stage shown in S5 below, to be subsequently executed based on the “denoising result corresponding to the N₃^{th} third time step”.

To minimize the impact of the image provided by the user on regions other than the target object, the present disclosure further provides an implementation of the aforementioned third result. In this implementation, when the target text includes a target entity and the target entity belongs to a preset entity type, the third result may further include an attention map of the target entity, with the attention map being used to describe an image region where the target entity is located. For details regarding the target entity and the attention map, reference can be made to the aforementioned content.

Based on the relevant content of the aforementioned S4, it can be seen that for the third stage provided in the present disclosure, when the third stage includes N₃ third time steps, the third stage can be as follows: first, processing a 1^{st} third time step, the aforementioned second result, and the text feature of the aforementioned target text using the third denoising network to at least obtain a denoising result corresponding to the 1^{st} third time step; next, processing a 2^{nd} third time step, the denoising result corresponding to the 1^{st} third time step, and the text feature using the third denoising network to at least obtain a denoising result corresponding to the 2^{nd} third time step; then, processing a 3^{rd} third time step, the denoising result corresponding to the 2^{nd} third time step, and the text feature using the third denoising network to obtain a denoising result corresponding to the 3^{rd} third time step; . . . (and so on); finally, processing an Nath third time step, a denoising result corresponding to an (N₃−1)^{th} third time step, and the text feature using the third denoising network to obtain the aforementioned third result, such as a denoising result corresponding to the N₃^{th} third time step, and an attention map of the aforementioned target entity, thereby enabling the following fourth stage to be subsequently executed based on the third result.

S5: Process the at least one fourth time step, the third result, the text feature, and the ID feature using a fourth denoising network to obtain a second image, where input data to a self attention module within the fourth denoising network includes the ID feature, and input data to a cross attention module within the fourth denoising network includes the text feature.

The fourth denoising network refers to another type of denoising network required for use when performing image generation processing with a text and an image as constraint conditions, enabling the fourth denoising network to utilize the text feature of the text and the ID feature of the target object in the image respectively through different attention processing methods, for example, utilizing the text feature through cross attention processing and utilizing the ID feature through self attention (SA) processing.

In a possible implementation, if the aforementioned third result at least includes the denoising result corresponding to the Nath third time step, when the fourth stage is implemented using the fourth denoising network, and the fourth stage includes N₄ fourth time steps, where N₄ is a positive integer, for example, N₄=15, the implementation process of the fourth stage is as follows.

First, the fourth denoising network processes a 1^{st} fourth time step, the aforementioned “denoising result corresponding to the Nath first time step”, the text feature of the aforementioned target text, and the ID feature of the target object in the aforementioned first image to obtain a denoising result corresponding to the 1^{st} fourth time step, enabling the “denoising result corresponding to the 1^{st} fourth time step” to represent the state presented after removing noise corresponding to all the first time steps, all the second time steps, all the third time steps, and the 1^{st} fourth time step.

Next, the fourth denoising network processes a 2^{nd} fourth time step, the “denoising result corresponding to the 1^{st} fourth time step”, the text feature of the aforementioned target text, and the ID feature of the target object in the aforementioned first image to obtain a denoising result corresponding to the 2^{nd} fourth time step, enabling the “denoising result corresponding to the 2^{nd} fourth time step” to represent the state presented after removing noise corresponding to all the first time steps, all the second time steps, all the third time steps, and the first two fourth time step.

Then, the fourth denoising network processes a 3^{rd} fourth time step, the “denoising result corresponding to the 2^{nd} fourth time step”, the text feature of the aforementioned target text, and the ID feature of the target object in the aforementioned first image to obtain a denoising result corresponding to the 3^{rd} fourth time step, enabling the “denoising result corresponding to the 3^{rd} fourth time step” to represent the state presented after removing noise corresponding to all the first time steps, all the second time steps, all the third time steps, and the first three fourth time step.

### . . . (And so on.)

Finally, the fourth denoising network processes an N₄^{th} fourth time step, the denoising result corresponding to the (N₄−1)^{th} fourth time step, the text feature of the aforementioned target text, and the ID feature of the target object in the aforementioned first image to obtain a denoising result corresponding to the Nath fourth time step, enabling the “denoising result corresponding to the N₄^{th} fourth time step” to represent the state presented after removing noise corresponding to all the time steps. This enables the “denoising result corresponding to the N₄^{th} fourth time step” to represent an image obtained after undergoing the four stages. Therefore, a second image can be determined based on the “denoising result corresponding to the N₄^{th} fourth time step”, thereby enabling the second image to represent a new image generated after undergoing the four stages.

Additionally, for an n₄^{th} fourth time step, when the n₄^{th} fourth time step is processed using the fourth denoising network, the input data to the self attention module within the fourth denoising network may include the ID feature of the target object in the aforementioned first image, and the input data to the cross attention module within the fourth denoising network may include the text feature of the aforementioned target text, thereby enabling the self attention module to perform attention processing on the ID feature and the feature map of a noise image corresponding to the n₄^{th} fourth time step and enabling the cross attention module to perform cross attention processing on the text feature and a feature map input to the cross attention module, so that the fourth denoising network can perform self attention processing under the constraint of the ID feature. This is conducive to better promoting the identifying characteristics of the target object in the finally generated new image to be closer to those of the target object in the first image provided by the user, thereby contributing to an improved ID feature retention capability. The “feature map input to the cross attention module” refers to a feature map received by the cross attention module when the n₄^{th} fourth time step is processed using the fourth denoising network, for example, a feature map provided to the cross attention module by other modules, such as a self attention module, during the processing by the fourth denoising network, or alternatively, a feature map of a noise image corresponding to the n₄^{th} fourth time step, and the like. Here, n₄ is a positive integer, with n₄≤N₄.

In addition, for the aforementioned n₄^{th} fourth time step, the noise image corresponding to the n₄^{th} fourth time step refers to the noise image involved when the n₄^{th} fourth time step is processed using the fourth denoising network. When n₄=1, and the aforementioned “denoising result corresponding to the N₃^{th} third time step” is a noise image, the noise image corresponding to the n₄^{th} fourth time step is the “denoising result corresponding to the N₃^{th} third time step”; when n₄≥2, and the denoising result corresponding to the (n₄−1)^{th} fourth time step is a noise image, the noise image corresponding to the n₄^{th} fourth time step may be the “denoising result corresponding to the (n₄−1)^{th} fourth time step”.

Furthermore, for the aforementioned n₄^{th} fourth time step, a feature map corresponding to the n₄^{th} fourth time step refers to a feature map for the noise image corresponding to the n₄^{th} fourth time step, so that the “feature map corresponding to the n₄^{th} fourth time step” is used to represent the information carried by the noise image corresponding to the n₄^{th} fourth time step. It should be noted that the present disclosure does not impose limitations on the implementation of the “feature map corresponding to the n₄^{th} fourth time step”. For instance, the “feature map corresponding to the n₄^{th} fourth time step” may be obtained by performing image feature extraction processing on the noise image corresponding to the n₄^{th} fourth time step. For another example, when n₄≥2, and the denoising result corresponding to the aforementioned (n₄−1)^{th} fourth time step is a noise image, the “feature map corresponding to the n₄^{th} fourth time step” may be obtained during the generation process of the “denoising result corresponding to the (n₄−1)^{th} fourth time step”. For yet another example, when n₄≥2, and the “denoising result corresponding to the (n₄−1)^{th} fourth time step” is a feature map, the “feature map corresponding to the n₄^{th} fourth time step” may be implemented using the “denoising result corresponding to the (n₄−1)^{th} fourth time step”.

In a possible implementation, for any fourth time step among the aforementioned at least one fourth time step, a noise image corresponding to the fourth time step is determined based on the fourth time step and the aforementioned third result, thereby allowing the feature map corresponding to the fourth time step to be used to describe the information carried by the noise image corresponding to the fourth time step.

Based on the relevant content of the feature maps of the aforementioned time steps, it can be seen that, in a possible implementation, for any time step in the aforementioned time step sequence, the feature map corresponding to the time step may be determined based on the noise image corresponding to that time step, thereby allowing the feature map corresponding to the time step to be used to describe the information carried by the noise image corresponding to that time step. To facilitate understanding, the following will provide explanations in conjunction with examples.

As an example, when the aforementioned time step sequence is {Step₃₀, Step₂₉, Step₂₈, Step₂₇, . . . , Step₁}, the process of determining feature maps corresponding to the time steps in the time step sequence is as follows: determining a feature map corresponding to the Step₃₀ based on the noise to be processed, thereby enabling denoising processing to be subsequently performed once on the feature map corresponding to the Step₃₀ to obtain a denoising result corresponding to the Step₃₀; determining a feature map corresponding to the Step₂₉ based on the denoising result corresponding to the Step₃₀, thereby enabling denoising processing to be subsequently performed once on the feature map corresponding to the Step₂₉ to obtain a denoising result corresponding to the Step₂₉; determining a feature map corresponding to the Step₂₈ based on the denoising result corresponding to the Step₂₉, thereby enabling denoising processing to be subsequently performed once on the feature map corresponding to the Step₂₈ to obtain a denoising result corresponding to the Step₂₈; . . . (and so on); determining a feature map corresponding to the Step₁ based on the denoising result corresponding to the Step2, thereby enabling denoising processing to be subsequently performed once on the feature map corresponding to the Step₁ to obtain a denoising result corresponding to the Step₁.

Additionally, the present disclosure does not impose limitations on the implementation of the aforementioned fourth denoising network. For instance, it may be implemented using a denoising network in any existing or future diffusion model capable of performing cross attention processing based on a text and performing self attention processing based on an image.

To further improve the image generation effect, the present disclosure further provides a possible implementation of the aforementioned fourth denoising network. In this implementation, for any fourth time step, the self attention module within the fourth denoising network is configured to perform attention processing based on the ID feature of the target object in the aforementioned first image and the feature map corresponding to the fourth time step, and the cross attention module within the fourth denoising network is configured to perform cross attention processing based on the text feature of the aforementioned target text and the feature map corresponding to the fourth time step, thereby facilitating enhancing the degree of constraint imposed by the first image on the generation of the target object.

The self attention module within the fourth denoising network introduces the constraint condition of the ID feature of the target object in the aforementioned first image, and the cross attention module within the fourth denoising network introduces the constraint condition of the text feature of the target text, so that the fourth stage implemented based on the fourth denoising network performs ID feature constraint through self attention processing, thereby enabling the fourth stage to timely correct the target object based on the ID feature. Consequently, this can effectively avoid defects caused by changes in the ID feature of the target object during the free generation in the third stage, thereby contributing to an improved ID feature retention capability.

To minimize the impact of the image provided by the user on regions other than the target object, the present disclosure further provides a possible implementation of the aforementioned fourth denoising network. In this implementation, when the aforementioned third result further includes the attention map of the target entity, which is used to describe the image region where the target entity is located, for any fourth time step, the self attention module within the fourth denoising network is configured to: perform attention processing based on the ID feature of the target object in the aforementioned first image and the image region in a feature map corresponding to the fourth time step. This can ensure, as much as possible, that the ID feature is used exclusively to constrain the region where the target object is located, thereby effectively reducing the impact of the image provided by the user on regions other than the target object.

To further improve the image generation effect, the present disclosure further provides a possible implementation of the aforementioned fourth denoising network. In this implementation, the fourth denoising network may include at least a fourth noise predictor, such as the noise predictor shown in FIG. 4, and the self attention module within the fourth denoising network includes a self attention module within the fourth noise predictor, and the cross attention module within the fourth denoising network includes a cross attention module within the fourth noise predictor.

For the fourth noise predictor described in the preceding paragraph, such as the noise predictor shown in FIG. 4, the fourth noise predictor refers to a module present in the fourth denoising network that is configured to perform noise prediction processing for a single time step, such as a Unet. Furthermore, the self attention module within the fourth noise predictor is capable of utilizing the ID feature of the target object in the aforementioned first image through self attention processing, while the cross attention module within the fourth noise predictor is capable of utilizing the text feature of the aforementioned target text through cross attention processing. It can be seen that different types of attention modules within the fourth noise predictor respectively introduce the two constraint conditions of the text feature and the ID feature, so that the fourth stage implemented based on the fourth noise predictor is constrained by the ID feature, thereby contributing to an improved ID feature retention capability. It should be noted that the present disclosure does not impose limitations on the implementation of the fourth noise predictor. For instance, it may be implemented using the noise predictor shown in FIG. 4.

In practice, to further improve the image generation effect, the present disclosure further provides a possible implementation of the aforementioned fourth denoising network. In this implementation, the fourth denoising network may be a denoising network in a fourth diffusion model, where the fourth diffusion model is configured to perform image generation processing with a text and an image as constraint conditions, such as performing cross attention processing based on the text and performing self attention processing based on the image.

Additionally, the present disclosure does not impose limitations on the implementation of the fourth diffusion model. For instance, the fourth diffusion model may be implemented using any existing or future diffusion model capable of performing cross attention processing based on a text and performing self attention processing based on an image. For another example, in some scenarios, the fourth diffusion model may include a text encoder, an ID feature extraction module, and a fourth denoising network, where the input data to the self attention module within the fourth denoising network includes the output data from the ID feature extraction module, and the input data to the cross attention module within the fourth denoising network includes the output data from the text encoder. For details regarding the text encoder and the ID feature extraction module, reference can be made to the aforementioned content.

Additionally, the present disclosure does not impose limitations on the method for obtaining the fourth diffusion model. For instance, it may be implemented using any existing or future method capable of constructing or training a diffusion model that has the functionality of performing cross attention processing based on a text and performing self attention processing based on an image.

The second image refers to a new image generated using the target text and the first image as constraint conditions, enabling the second image to represent the result obtained through the four-stage image generation process.

Based on the relevant content of the aforementioned S1 to S5, it can be seen that, the image generation method according to the embodiments of the present disclosure includes: first, obtaining noise to be processed, a time step sequence, a text feature of a target text, and an identity document (ID) feature of a target object in a first image, so that the time step sequence includes at least one first time step, at least one second time step, at least one third time step, and at least one fourth time step; next, processing the at least one first time step, the noise to be processed, and the text feature using a first denoising network to obtain a first result; next, processing the at least one second time step, the first result, the text feature, and the ID feature using a second denoising network to obtain a second result; subsequently, processing the at least one third time step, the second result, and the text feature using a third denoising network to obtain a third result; and finally, processing the at least one fourth time step, the third result, the text feature, and the ID feature using a fourth denoising network to obtain a second image, thereby meeting the aforementioned image generation requirements.

As can be seen, the present disclosure provides a four-stage image generation process, which is as follows: the first stage is used for free generation without the constraint of an ID feature; the second stage is used for generation through cross attention processing constrained by the ID feature; the third stage is used again for free generation without the constraint of the ID feature; and the fourth stage is used for generation through self attention processing constrained by the ID feature. This enables the image generation process to meet the following requirements: constructing the overall image structure described by the target text as early as possible; ensuring the optimal timing for introducing the ID feature to avoid a decrease in the editing capability caused by introducing the ID feature too early or a decrease in the ID feature retention capability caused by introducing the ID feature too late; and diversifying the usage method for the ID feature as much as possible to avoid defects caused by a single usage method, so that the image generation process can possess both a good ID feature retention capability and a good editing capability, thereby contributing to an improved image generation effect.

Additionally, to further improve the image generation effect, the present disclosure further provides a possible implementation of the aforementioned second diffusion model. In this implementation, the second diffusion model is obtained by structurally adjusting and training the first diffusion model, resulting in certain similarities between the second diffusion model and the first diffusion model. This allows better compatibility between the second stage implemented based on the denoising network in the second diffusion model and the first stage implemented based on the denoising network in the first diffusion model, thereby contributing to an improved image generation effect.

In addition, the present disclosure does not impose limitations on the method for obtaining the second diffusion model described in the preceding paragraph. For instance, it may include the following steps 11 and 12.

Step 11: Structurally adjust the first diffusion model, so that an ID feature extraction module and parameters required for use when introducing output data of the ID feature extraction module into the cross attention module are added to the adjusted first diffusion model, compared to the original first diffusion model before adjustment, thereby enabling the adjusted first diffusion model to perform cross attention processing based on reference texts and images.

Step 12: Train the adjusted first diffusion model using some sample texts and labeled images corresponding to these sample texts to obtain the second diffusion model.

The sample text refers to the text required for use in model training; furthermore, the present disclosure does not impose limitations on the implementation of the sample text.

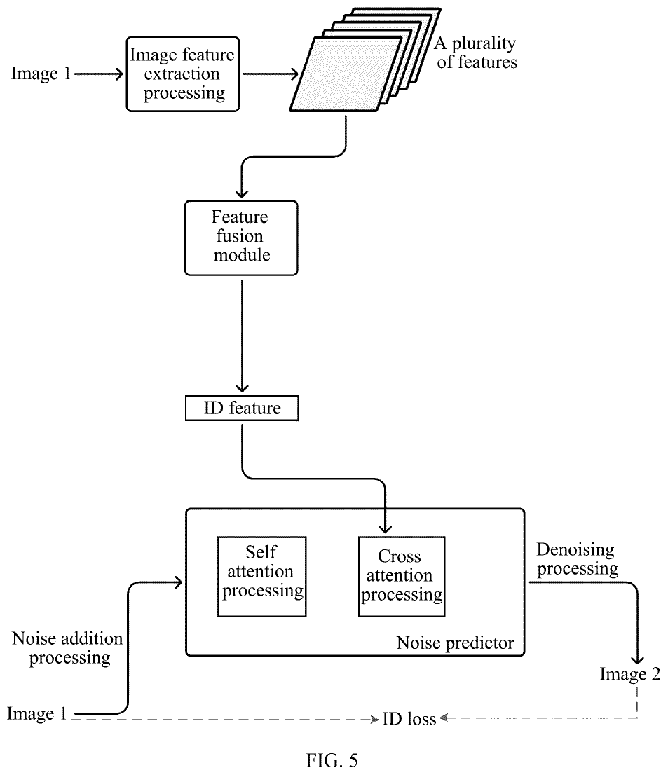

Additionally, for any sample text, the labeled image corresponding to the sample text refers to a ground-truth image corresponding to the sample text, such as Image 1 shown in FIG. 5. Furthermore, the following constraint is satisfied between the labeled image and the sample text: the information described by the labeled image remains consistent with the semantic information expressed by the sample text, thereby enabling the labeled image to be used to guide the image generation process for the sample text. It should be noted that the present disclosure does not impose limitations on the method for obtaining the labeled image. For example, it may be implemented by means of manual annotation.

Additionally, the present disclosure does not impose limitations on the implementation of the aforementioned step 12. For example, it may include the following steps 121 to 123.

Step 121: Obtain sample texts and labeled images corresponding to these sample texts, such as Image 1 shown in FIG. 5.

Step 122: Process a sample text and a labeled image corresponding to the sample text using the adjusted first diffusion model to obtain a generated image corresponding to the sample text, such as Image 2 shown in FIG. 5.

Step 123: Update newly added learnable parameters in the adjusted first diffusion model based on an ID loss between the generated image corresponding to the sample text and the labeled image corresponding to the sample text, and return to execute the aforementioned Step 121 and its subsequent steps until a preset stopping condition is met, and determine the adjusted first diffusion model as the second diffusion model.

The ID loss is used to represent the ID feature retention capability of the adjusted first diffusion model, and the ID loss is determined based on the difference between the generated image corresponding to the sample text and the labeled image corresponding to the sample text.

Additionally, the present disclosure does not impose limitations on the method for calculating the aforementioned ID loss. For example, it may include: first, processing the generated image corresponding to the sample text using a pre-constructed target object recognition model to obtain an image feature of the generated image, so that the image feature of the generated image can represent identifying characteristics of the target object presented in the generated image, and processing the labeled image corresponding to the sample text using the target object recognition model to obtain an image feature of the labeled image, so that the image feature of the labeled image can represent identifying characteristics of the target object presented in the labeled image; then, calculating a difference between the image feature of the generated image and the image feature of the labeled image, such as cosine similarity; and finally, determining this difference as the ID loss.

In addition, for the aforementioned adjusted first diffusion model, the newly added learnable parameters in the adjusted first diffusion model refer to learnable parameters added to the adjusted first diffusion model compared to the original first diffusion model before adjustment, such as parameters within a feature fusion module in the ID feature extraction module and the parameters required for use when introducing the output data of the ID feature extraction module into the cross attention module.

The preset stopping condition refers to a preset condition that must be met to stop training. Furthermore, the present disclosure does not impose limitations on the preset stopping condition. For example, the preset stopping condition may include: the ID loss is below a preset loss threshold. For another example, the preset stopping condition may include: the change rate of the ID loss is less than a preset change rate threshold. For yet another example, the preset stopping condition may include: the number of updates to the adjusted first diffusion model reaches a preset number threshold.

Based on the relevant content of the aforementioned steps 121 to 123, it can be seen that, in some scenarios, the second diffusion model may be obtained by training the newly added learnable parameters in the adjusted first diffusion model, so that parameters other than the newly added learnable parameters in the second diffusion model remain consistent with those in the original first diffusion model before adjustment, resulting in certain similarities between the second diffusion model and the original first diffusion model before adjustment. This allows better compatibility between the second stage implemented based on the denoising network in the second diffusion model and the first stage implemented based on the denoising network in the first diffusion model, thereby contributing to an improved image generation effect.

Based on the relevant content of the aforementioned steps 11 and 12, it can be seen that, in some scenarios, the second diffusion model may be obtained by structurally adjusting and training the first diffusion model, resulting in certain similarities between the second diffusion model and the first diffusion model. This allows better compatibility between the second stage implemented based on the denoising network in the second diffusion model and the first stage implemented based on the denoising network in the first diffusion model, thereby contributing to an improved image generation effect.

Additionally, to further improve the image generation effect, the present disclosure further provides a possible implementation of the aforementioned third diffusion model. In this implementation, the third diffusion model may be obtained by deleting ID feature-related parts from the aforementioned second diffusion model, such as the ID feature extraction module and the parameters required for use when introducing the output data of the ID feature extraction module into the cross attention module, and other parts, resulting in certain similarities among the third diffusion model, the second diffusion model, and the first diffusion model. This allows better compatibility among the first three stages implemented based on the denoising networks in these three models, thereby contributing to an improved image generation effect.

Additionally, to further improve the image generation effect, the present disclosure further provides a possible implementation of the aforementioned fourth diffusion model. In this implementation, the fourth diffusion model is obtained by structurally adjusting the aforementioned second diffusion model, resulting in certain similarities among the fourth diffusion model, the third diffusion model, the second diffusion model, and the first diffusion model. This allows better compatibility among the four stages implemented based on the denoising networks in these four models, thereby contributing to an improved image generation effect.

In addition, the present disclosure does not impose limitations on the method for obtaining the fourth diffusion model described in the preceding paragraph. For instance, it may be: structurally adjusting the second diffusion model to obtain the fourth diffusion model, so that the following differences exist between the fourth diffusion model and the second diffusion model: (1) the ID feature extraction module within the fourth diffusion model is connected to the self attention module within the fourth diffusion model, whereas the ID feature extraction module within the second diffusion model is not connected to the self attention module within the second diffusion model; (2) the ID feature extraction module within the fourth diffusion model is not connected to the cross attention module within the fourth diffusion model, whereas the ID feature extraction module within the second diffusion model is connected to the cross attention module within the second diffusion model; and (3) the cross attention module within the fourth diffusion model is the same as the cross attention module within the first diffusion model, whereas the cross attention module within the second diffusion model is obtained by adding certain parameters, such as the parameters required for use when introducing the output data of the ID feature extraction module into the cross attention module, to the cross attention module within the first diffusion model.

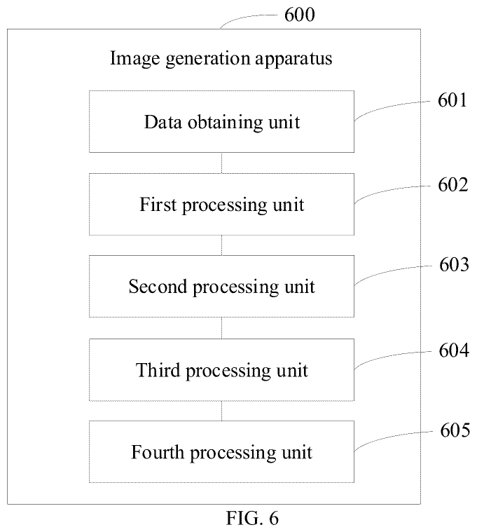

Based on the image generation method according to the embodiments of the present disclosure, an embodiment of the present disclosure further provides an image generation apparatus, which is explained and illustrated below in connection with FIG. 6. FIG. 6 is a schematic diagram of a structure of an image generation apparatus according to an embodiment of the present disclosure. It should be noted that, for technical details of the image generation apparatus according to this embodiment of the present disclosure, reference can be made to the relevant content of the aforementioned image generation method.

As shown in FIG. 6, the image generation apparatus 600 according to this embodiment of the present disclosure includes: a data obtaining unit 601, a first processing unit 602, a second processing unit 603, a third processing unit 604 and a fourth processing unit 605.

The data obtaining unit 601 is configured to obtain noise to be processed, a time step sequence, a text feature of a target text, and an identity document (ID) feature of a target object in a first image, where the time step sequence includes at least one first time step, at least one second time step, at least one third time step, and at least one fourth time step.

The first processing unit 602 configured to process the at least one first time step, the noise to be processed, and the text feature using a first denoising network to obtain a first result, where input data to a cross attention module within the first denoising network includes the text feature;

The second processing unit 603 configured to process the at least one second time step, the first result, the text feature, and the ID feature using a second denoising network to obtain a second result, where input data to a cross attention module within the second denoising network includes the text feature and the ID feature.

The third processing unit 604 configured to process the at least one third time step, the second result, and the text feature using a third denoising network to obtain a third result, where input data to a cross attention module within the third denoising network includes the text feature.

The fourth processing unit 605 configured to process the at least one fourth time step, the third result, the text feature, and the ID feature using a fourth denoising network to obtain a second image, where input data to a self attention module within the fourth denoising network includes the ID feature, and input data to a cross attention module within the fourth denoising network includes the text feature.

In a possible implementation, for any time step in the time step sequence, a feature map corresponding to the time step is used to represent information carried by a noise image corresponding to the time step, with the noise image corresponding to the time step being determined based on the time step and the noise to be processed; for any first time step, the cross attention module within the first denoising network is configured to perform cross attention processing based on the text feature and a feature map corresponding to the first time step; for any second time step, the cross attention module within the second denoising network is configured to perform cross attention processing based on the text feature, the ID feature, and a feature map corresponding to the second time step; for any third time step, the cross attention module within the third denoising network is configured to perform cross attention processing based on the text feature and a feature map corresponding to the third time step; and for any fourth time step, the self attention module within the fourth denoising network is configured to perform attention processing based on the ID feature and a feature map corresponding to the fourth time step, and the cross attention module within the fourth denoising network is configured to perform cross attention processing based on the text feature and the feature map corresponding to the fourth time step.

In a possible implementation, for any first time step, a noise image corresponding to the first time step is determined based on the first time step and the noise to be processed; for any second time step, a noise image corresponding to the second time step is determined based on the second time step and the first result; for any third time step, a noise image corresponding to the third time step is determined based on the third time step and the second result; and for any fourth time step, a noise image corresponding to the fourth time step is determined based on the fourth time step and the third result.

In a possible implementation, the target text includes a target entity, with the target entity belonging to a preset entity type; the first result includes an attention map of the target entity, with the attention map being used to describe an image region where the target entity is located; and for any second time step, the cross attention module within the second denoising network is configured to: process the image region in a feature map corresponding to the second time step based on the ID feature, and process regions other than the image region in the feature map corresponding to the second time step based on the text feature.

In a possible implementation, the target text includes a target entity, with the target entity belonging to a preset entity type; the third result includes an attention map of the target entity, with the attention map being used to describe an image region where the target entity is located; and for any fourth time step, the self attention module within the fourth denoising network is configured to: perform attention processing based on the ID feature and the image region in a feature map corresponding to the fourth time step.

In a possible implementation, a process of determining the target entity includes: performing entity recognition processing on the target text to obtain a plurality of candidate entities, each of the candidate entities belonging to the preset entity type; and searching for a target entity that matches the first image from among the plurality of candidate entities.

In a possible implementation, the first denoising network is a denoising network in a first diffusion model, with the first diffusion model further including a text encoder, where the input data to the cross attention module within the first denoising network includes output data from the text encoder; the second denoising network is a denoising network in a second diffusion model, with the second diffusion model further including the text encoder and an ID feature extraction module, where the input data to the cross attention module within the second denoising network includes the output data from the text encoder and output data from the ID feature extraction module; the third denoising network is a denoising network in a third diffusion model, with the third diffusion model further including the text encoder, where the input data to the cross attention module within the third denoising network includes the output data from the text encoder; and the fourth denoising network is a denoising network in a fourth diffusion model, with the fourth diffusion model further including the text encoder and the ID feature extraction module, where the input data to the self attention module within the fourth denoising network includes the output data from the ID feature extraction module, and the input data to the cross attention module within the fourth denoising network includes the output data from the text encoder.

In a possible implementation, the text feature is obtained by encoding the target text through the text encoder; and the ID feature of the target object in the first image is obtained by processing the first image through the ID feature extraction module.

In a possible implementation, the ID feature extraction module includes a multi-layer feature extraction module and a feature fusion module, with output data from the multi-layer feature extraction module including image features of a plurality of sizes, and the feature fusion module being configured to perform fusion processing on image features of some or all of the plurality of sizes.

In a possible implementation, the first denoising network includes a first noise predictor, and the cross attention module within the first denoising network includes a cross attention module within the first noise predictor; the second denoising network includes a second noise predictor, and the cross attention module within the second denoising network includes a cross attention module within the second noise predictor; the third denoising network includes a third noise predictor, and the cross attention module within the third denoising network includes a cross attention module within the third noise predictor; and the fourth denoising network includes a fourth noise predictor, and the self attention module within the fourth denoising network includes a self attention module within the fourth noise predictor, and the cross attention module within the fourth denoising network includes a cross attention module within the fourth noise predictor.

Based on the relevant content of the image generation apparatus 600 described above, it can be seen that the working principle of the image generation apparatus 600 according to the present disclosure is as follows: first, obtaining noise to be processed, a time step sequence, a text feature of a target text, and an identity document (ID) feature of a target object in a first image, so that the time step sequence includes at least one first time step, at least one second time step, at least one third time step, and at least one fourth time step; next, processing the at least one first time step, the noise to be processed, and the text feature using a first denoising network to obtain a first result; next, processing the at least one second time step, the first result, the text feature, and the ID feature using a second denoising network to obtain a second result; subsequently, processing the at least one third time step, the second result, and the text feature using a third denoising network to obtain a third result; and finally, processing the at least one fourth time step, the third result, the text feature, and the ID feature using a fourth denoising network to obtain a second image, thereby meeting the aforementioned image generation requirements.

It can be seen that the image generation apparatus 600 according to the present disclosure implements a four-stage image generation process, which is as follows: the first stage is used for free generation without the constraint of an ID feature; the second stage is used for generation through cross attention processing constrained by the ID feature; the third stage is used again for free generation without the constraint of the ID feature; and the fourth stage is used for generation through self attention processing constrained by the ID feature, thereby enabling the image generation process to meet the following requirements: constructing the overall image structure described by the target text as early as possible; ensuring the optimal timing for introducing the ID feature to avoid a decrease in the editing capability caused by introducing the ID feature too early or a decrease in the ID feature retention capability caused by introducing the ID feature too late; and diversifying the usage method for the ID feature as much as possible to avoid defects caused by a single usage method, so that the image generation process can possess both a good ID feature retention capability and a good editing capability, thereby contributing to an improved image generation effect.

In addition, an embodiment of the present disclosure further provides an electronic device. The device includes a processor and a memory. The memory is configured to store instructions or a computer program; and the processor is configured to execute the instructions or computer program in the memory to enable the electronic device to perform any implementation of the image generation method according to the embodiments of the present disclosure.

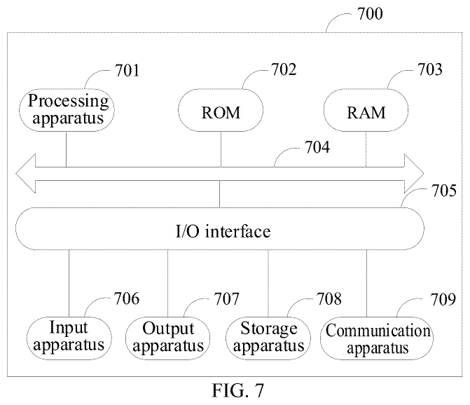

Reference is made to FIG. 7, which is a schematic diagram of a structure of an electronic device 700 suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and an in-vehicle terminal (e.g., an in-vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

According to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present disclosure further provides a computer-readable medium having instructions or a computer program stored therein which, when run on a device, cause the device to perform any implementation of the image generation method according to the embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, enable the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “include”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure is not limited to the embodiments described herein but is to be accorded with the broadest scope consistent with the principle and novel features disclosed herein.

1. An image generation method, comprising:
obtaining noise to be processed, a time step sequence, a text feature of a target text, and an identity document (ID) feature of a target object in a first image, wherein the time step sequence comprises at least one first time step, at least one second time step, at least one third time step, and at least one fourth time step;
processing the at least one first time step, the noise to be processed, and the text feature using a first denoising network to obtain a first result, wherein input data to a cross attention module within the first denoising network comprises the text feature;
processing the at least one second time step, the first result, the text feature, and the ID feature using a second denoising network to obtain a second result, wherein input data to a cross attention module within the second denoising network comprises the text feature and the ID feature;
processing the at least one third time step, the second result, and the text feature using a third denoising network to obtain a third result, wherein input data to a cross attention module within the third denoising network comprises the text feature; and
processing the at least one fourth time step, the third result, the text feature, and the ID feature using a fourth denoising network to obtain a second image, wherein input data to a self attention module within the fourth denoising network comprises the ID feature, and input data to a cross attention module within the fourth denoising network comprises the text feature.

2. The method according to claim 1, wherein for any time step in the time step sequence, a feature map corresponding to the time step is used to represent information carried by a noise image corresponding to the time step, with the noise image corresponding to the time step being determined based on the time step and the noise to be processed;
wherein for any first time step, the cross attention module within the first denoising network is configured to perform cross attention processing based on the text feature and a feature map corresponding to the first time step;
wherein for any second time step, the cross attention module within the second denoising network is configured to perform cross attention processing based on the text feature, the ID feature, and a feature map corresponding to the second time step;
wherein for any third time step, the cross attention module within the third denoising network is configured to perform cross attention processing based on the text feature and a feature map corresponding to the third time step; and
wherein for any fourth time step, the self attention module within the fourth denoising network is configured to perform attention processing based on the ID feature and a feature map corresponding to the fourth time step, and the cross attention module within the fourth denoising network is configured to perform cross attention processing based on the text feature and the feature map corresponding to the fourth time step.

3. The method according to claim 2, wherein for any first time step, a noise image corresponding to the first time step is determined based on the first time step and the noise to be processed;
wherein for any second time step, a noise image corresponding to the second time step is determined based on the second time step and the first result;
wherein for any third time step, a noise image corresponding to the third time step is determined based on the third time step and the second result; and
wherein for any fourth time step, a noise image corresponding to the fourth time step is determined based on the fourth time step and the third result.

4. The method according to claim 2, wherein the target text comprises a target entity, with the target entity belonging to a preset entity type;
wherein the first result comprises an attention map of the target entity, with the attention map being used to describe an image region where the target entity is located; and
wherein, for any second time step, the cross attention module within the second denoising network is configured to: process the image region in a feature map corresponding to the second time step based on the ID feature, and process regions other than the image region in the feature map corresponding to the second time step based on the text feature.

5. The method according to claim 2, wherein the target text comprises a target entity, with the target entity belonging to a preset entity type;
wherein the third result comprises an attention map of the target entity, with the attention map being used to describe an image region where the target entity is located; and
wherein, for any fourth time step, the self attention module within the fourth denoising network is configured to: perform attention processing based on the ID feature and the image region in a feature map corresponding to the fourth time step.

6. The method according to claim 4, wherein a process of determining the target entity comprises:
performing entity recognition processing on the target text to obtain a plurality of candidate entities, each of the candidate entities belonging to the preset entity type; and
searching for a target entity that matches the first image from among the plurality of candidate entities.

7. The method according to claim 1, wherein the first denoising network is a denoising network in a first diffusion model, with the first diffusion model further comprising a text encoder, wherein the input data to the cross attention module within the first denoising network comprises output data from the text encoder;
wherein the second denoising network is a denoising network in a second diffusion model, with the second diffusion model further comprising the text encoder and an ID feature extraction module, wherein the input data to the cross attention module within the second denoising network comprises the output data from the text encoder and output data from the ID feature extraction module;
wherein the third denoising network is a denoising network in a third diffusion model, with the third diffusion model further comprising the text encoder, wherein the input data to the cross attention module within the third denoising network comprises the output data from the text encoder; and
wherein the fourth denoising network is a denoising network in a fourth diffusion model, with the fourth diffusion model further comprising the text encoder and the ID feature extraction module, wherein the input data to the self attention module within the fourth denoising network comprises the output data from the ID feature extraction module, and the input data to the cross attention module within the fourth denoising network comprises the output data from the text encoder.

8. The method according to claim 7, wherein the text feature is obtained by encoding the target text through the text encoder; and
wherein the ID feature of the target object in the first image is obtained by processing the first image through the ID feature extraction module.

9. The method according to claim 7, wherein the ID feature extraction module comprises a multi-layer feature extraction module and a feature fusion module, with output data from the multi-layer feature extraction module comprising image features of a plurality of sizes, and the feature fusion module being configured to perform fusion processing on image features of some or all of the plurality of sizes.

10. The method according to claim 1, wherein the first denoising network comprises a first noise predictor, and the cross attention module within the first denoising network comprises a cross attention module within the first noise predictor;
the second denoising network comprises a second noise predictor, and the cross attention module within the second denoising network comprises a cross attention module within the second noise predictor;
the third denoising network comprises a third noise predictor, and the cross attention module within the third denoising network comprises a cross attention module within the third noise predictor; and
the fourth denoising network comprises a fourth noise predictor, and the self attention module within the fourth denoising network comprises a self attention module within the fourth noise predictor, and the cross attention module within the fourth denoising network comprises a cross attention module within the fourth noise predictor.

11. An electronic device, comprising: a processor and a memory, wherein
the memory is configured to store instructions; and
the processor is configured to execute the instructions in the memory to cause the electronic device to perform an image generation method, wherein the method comprises:
obtaining noise to be processed, a time step sequence, a text feature of a target text, and an identity document (ID) feature of a target object in a first image, wherein the time step sequence comprises at least one first time step, at least one second time step, at least one third time step, and at least one fourth time step;
processing the at least one first time step, the noise to be processed, and the text feature using a first denoising network to obtain a first result, wherein input data to a cross attention module within the first denoising network comprises the text feature;
processing the at least one second time step, the first result, the text feature, and the ID feature using a second denoising network to obtain a second result, wherein input data to a cross attention module within the second denoising network comprises the text feature and the ID feature;
processing the at least one third time step, the second result, and the text feature using a third denoising network to obtain a third result, wherein input data to a cross attention module within the third denoising network comprises the text feature; and
processing the at least one fourth time step, the third result, the text feature, and the ID feature using a fourth denoising network to obtain a second image, wherein input data to a self attention module within the fourth denoising network comprises the ID feature, and input data to a cross attention module within the fourth denoising network comprises the text feature.

12. The electronic device according to claim 11, wherein for any time step in the time step sequence, a feature map corresponding to the time step is used to represent information carried by a noise image corresponding to the time step, with the noise image corresponding to the time step being determined based on the time step and the noise to be processed;
wherein for any first time step, the cross attention module within the first denoising network is configured to perform cross attention processing based on the text feature and a feature map corresponding to the first time step;
wherein for any second time step, the cross attention module within the second denoising network is configured to perform cross attention processing based on the text feature, the ID feature, and a feature map corresponding to the second time step;
wherein for any third time step, the cross attention module within the third denoising network is configured to perform cross attention processing based on the text feature and a feature map corresponding to the third time step; and
wherein for any fourth time step, the self attention module within the fourth denoising network is configured to perform attention processing based on the ID feature and a feature map corresponding to the fourth time step, and the cross attention module within the fourth denoising network is configured to perform cross attention processing based on the text feature and the feature map corresponding to the fourth time step.

13. The electronic device according to claim 12, wherein for any first time step, a noise image corresponding to the first time step is determined based on the first time step and the noise to be processed;
wherein for any second time step, a noise image corresponding to the second time step is determined based on the second time step and the first result;
wherein for any third time step, a noise image corresponding to the third time step is determined based on the third time step and the second result; and
wherein for any fourth time step, a noise image corresponding to the fourth time step is determined based on the fourth time step and the third result.

14. The electronic device according to claim 12, wherein the target text comprises a target entity, with the target entity belonging to a preset entity type;
wherein the first result comprises an attention map of the target entity, with the attention map being used to describe an image region where the target entity is located; and
wherein, for any second time step, the cross attention module within the second denoising network is configured to: process the image region in a feature map corresponding to the second time step based on the ID feature, and process regions other than the image region in the feature map corresponding to the second time step based on the text feature.

15. The electronic device according to claim 12, wherein the target text comprises a target entity, with the target entity belonging to a preset entity type;
wherein the third result comprises an attention map of the target entity, with the attention map being used to describe an image region where the target entity is located; and
wherein, for any fourth time step, the self attention module within the fourth denoising network is configured to: perform attention processing based on the ID feature and the image region in a feature map corresponding to the fourth time step.

16. The electronic device according to claim 14, wherein a process of determining the target entity comprises:
performing entity recognition processing on the target text to obtain a plurality of candidate entities, each of the candidate entities belonging to the preset entity type; and
searching for a target entity that matches the first image from among the plurality of candidate entities.

17. The electronic device according to claim 11, wherein the first denoising network is a denoising network in a first diffusion model, with the first diffusion model further comprising a text encoder, wherein the input data to the cross attention module within the first denoising network comprises output data from the text encoder;
wherein the second denoising network is a denoising network in a second diffusion model, with the second diffusion model further comprising the text encoder and an ID feature extraction module, wherein the input data to the cross attention module within the second denoising network comprises the output data from the text encoder and output data from the ID feature extraction module;
wherein the third denoising network is a denoising network in a third diffusion model, with the third diffusion model further comprising the text encoder, wherein the input data to the cross attention module within the third denoising network comprises the output data from the text encoder; and
wherein the fourth denoising network is a denoising network in a fourth diffusion model, with the fourth diffusion model further comprising the text encoder and the ID feature extraction module, wherein the input data to the self attention module within the fourth denoising network comprises the output data from the ID feature extraction module, and the input data to the cross attention module within the fourth denoising network comprises the output data from the text encoder.

18. The electronic device according to claim 17, wherein the text feature is obtained by encoding the target text through the text encoder; and
wherein the ID feature of the target object in the first image is obtained by processing the first image through the ID feature extraction module.

19. The electronic device according to claim 17, wherein the ID feature extraction module comprises a multi-layer feature extraction module and a feature fusion module, with output data from the multi-layer feature extraction module comprising image features of a plurality of sizes, and the feature fusion module being configured to perform fusion processing on image features of some or all of the plurality of sizes.

20. A non-transitory computer-readable medium, having instructions or a computer program stored therein which, when run on a device, causes the device to:
obtain noise to be processed, a time step sequence, a text feature of a target text, and an identity document (ID) feature of a target object in a first image, wherein the time step sequence comprises at least one first time step, at least one second time step, at least one third time step, and at least one fourth time step;
process the at least one first time step, the noise to be processed, and the text feature using a first denoising network to obtain a first result, wherein input data to a cross attention module within the first denoising network comprises the text feature;
process the at least one second time step, the first result, the text feature, and the ID feature using a second denoising network to obtain a second result, wherein input data to a cross attention module within the second denoising network comprises the text feature and the ID feature;
process the at least one third time step, the second result, and the text feature using a third denoising network to obtain a third result, wherein input data to a cross attention module within the third denoising network comprises the text feature; and
process the at least one fourth time step, the third result, the text feature, and the ID feature using a fourth denoising network to obtain a second image, wherein input data to a self attention module within the fourth denoising network comprises the ID feature, and input data to a cross attention module within the fourth denoising network comprises the text feature.
